(19) United States
(12) Patent Application Publication
(10) Pub. No.: US 2015/0127949 A1
(43) Pub. Date: May 7, 2015

(54) SYSTEM AND METHOD FOR INTEGRATED MESH AUTHENTICATION AND ASSOCIATION

(71) Applicant: QUALCOMM Incorporated, San Diego, CA (US)

(72) Inventors: Abhishek Pramod Patil, San Diego, CA (US); Soo Bum Lee, San Diego, CA (US); George Cherian, San Diego, CA (US); Santosh Paul Abraham, San Diego, CA (US)

(21) Appl. No.: 14/523,487

(22) Filed: Oct. 24, 2014

Related U.S. Application Data
(60) Provisional application No. 61/899,064, filed on Nov. 1, 2013.
(60) Provisional application No. 62/002,009, filed on May 22, 2014.

(51) Int. Cl. H04L 29/06; H04W 12/06; H04L 9/08; H04L 9/32

(52) U.S. Cl. CPC H04L 63/083; H04L 9/32; H04W 12/06; H04L 9/0861
USPC 713/181; 726/5; 713/168

(57) ABSTRACT

Systems and methods for more efficient mesh associations are disclosed. In some aspects, a non-member device may join a mesh network via a four way message exchange with any member device of the mesh network. The four way message exchange between the mesh member device and the non-member device provides for authentication and association between the two devices. As a result of the four way message exchange, a common group key is provided to the non-member device. The common group key is utilized by all mesh member devices to encrypt and decrypt group addressed mesh messages exchanged between any of the mesh member devices. Association identifiers for each of the two devices are also provided during the exchange. PHY/MAC capabilities may also be exchanged. In some aspects, IP address assignment for the two devices may also be accomplished during the four way message handshake.

### CROSS-REFERENCE TO RELATED APPLICATIONS

This application claims priority to U.S. Provisional Application No. 61/899,064, filed Nov. 1, 2013, and entitled “SYSTEM AND METHOD FOR EFFICIENT SECURE MESH PEERING.” This application also claims priority to U.S. Provisional Application No. 62/002,009, filed May 22, 2014, and entitled “SYSTEM AND METHOD FOR INTEGRATED MESH AUTHENTICATION AND ASSOCIATION.” The disclosures of these prior applications are considered part of this application, and are hereby incorporated by reference in their entirety.

### BACKGROUND

1. Field of the Invention

The present disclosure is generally related to neighborhood-aware networks (NANs) and more particularly to systems, methods, and devices for establishing mesh communications between two mesh peer devices.

2. Description of the Related Art

Simultaneous Authentication of Equals (SAE) is a password based authentication used primarily in point to point applications and infrastructure-less networks. SAE messages may carry a “nonce” generated by each device participating in the exchange. Using the exchanged “nonces,” a pairwise master key (PMK) is established. Authenticated Mesh Peering Exchange protocol (AMPE) exchanges “nonces” to facilitate generation of a pairwise transient key (PTK).

802.11s utilizes a combination of SAE authentication to establish a pairwise master key (PMK) as described above, and the AMPE protocol, which generates a PTK. The generated PTKs are not exchanged by the two devices performing AMPE for security reasons. Instead, possession of the same PTK by both devices is confirmed by exchanging messages containing a message integrity code (MIC). The MIC is generated based on the PTK. A group key is also established using the AMPE protocol.

Use of the SAE and AMPE protocols in mesh peering in 802.11s is inefficient, in that at least eight messages must be exchanged between each pair of devices before a mesh peer relationship is established. Thus, there is a need for more efficient mesh peering.

### SUMMARY OF THE INVENTION

Existing group key management processes have relatively high overhead and require substantial maintenance of state information in 802.11s. For example, each mesh station determines its own transmit mesh group key. The transmit mesh group key is then used to encrypt any group addressed transmissions to the mesh or group. Each mesh station is required to store separate receive mesh group keys for each mesh peer, which enables the mesh station to successfully decrypt any mesh messages received from each mesh peer. Moreover, when the configuration of the mesh changes, for example, such that a particular mesh peer device leaves the network, each remaining mesh device may discard its previous group key and generate a new group key. The new group key may then be redistributed to each of the remaining group peers.

The methods and systems disclosed provide for a light-weight mesh authentication mechanism which eliminates the complex and burdensome authentication processes described above. First, using the proposed methods and systems, a non-member station seeking to join a social Wi-Fi network is required to authenticate/associate with only one mesh member station. If the authentication/association is successful, the new mesh station is fully associated with the mesh network. This simplified approach is at least partly made possible by elimination of station-specific group keys for mesh communication as used by the existing systems described above. Instead, a common group key is used for all devices associated with the mesh network. This single common group key can be used by each associated device to encrypt and decrypt group addressed mesh network traffic. Some aspects may also encrypt unicast packets using the common group key—in such implementations, mesh traffic may also be encrypted using the group key.

The disclosed methods and systems apply messages similar to Fast Initial Link Setup (FILS) messages used in 802.11ai to the social Wi-Fi environment. The new messages also incorporate some features from Simultaneous Authentication of Equals (SAE) messages to accomplish mesh peer authentication and association using only a four way handshake. The common group key discussed above is shared with a new member device upon successful association via the proposed four way handshake. PHY/MAC capabilities may also be exchanged by the two devices during the authentication/association process. The proposed four way handshake also establishes association identifiers for each device participating in the exchange. The proposed four way handshake may also be used to establish IP addresses to be used by each device participating in the exchange during communication with the other device. For example, some of the proposed messages provide a way for a first device participating in the exchange to propose an IP address it prefers to use for communication with a second device of the exchange. Other messages provide a mechanism for either the first or second device to indicate which IP address the other device should use once the association process is complete.

One aspect disclosed is a method of peer association in a mesh network. The method includes receiving, via a non-member device of the mesh network, a password, transmitting, via the non-member device, an authentication request to a member device of the mesh network, the authentication request based on the password, receiving, via the non-member device, an authentication response from the member device, transmitting, via the non-member device, an association request to the member device based on the authentication response, the association request further based on the password, and receiving, via the non-member device, an association response from the member device.

Some aspects of the method also include generating a pairwise master key (PMK) based on the authentication response, decoding a nonce from the authentication response, generating a pairwise transient key (PTK) based on the pairwise master key (PMK), and the nonce; and generating the association request based on the pairwise transient key. Some aspects of the method also include generating a message integrity code (MIC) based on the pairwise transient key; and generating the association request to indicate the message integrity code. Some aspects of the method also include assigning an association identifier to the member device; and further generating the association request to indicate the association identifier of the member device. Some aspects of the method also include decoding an association identifier from the association response, generating a mesh message to comprise the association identifier; and transmitting the mesh message to the member device.

Some aspects of the method also include generating a first message integrity code (MIC) based on the password, decoding the association response to determine a second message integrity code (MIC), comparing the first message integrity code (MIC) to the second message integrity code (MIC); and determining whether the non-member device is associated with the member device based on the comparison. Some aspects of the method also include decoding a group key from the association response, receiving a mesh message from a second non-member device; and decoding the mesh message based on the group key. Some aspects of the method also include decoding a group key from the association response, generating a path request message to comprise a sequence number, encrypting the path request message based on the group key, and transmitting the encrypted path request message on the mesh network.

Some aspects of the method also include receiving a path response message from a second member device of the mesh, decoding the path response message based on the group key, decoding the sequence number from the decoded path response message; and associating with the second member device based on the decoded path response. Some aspects of the method also include decoding an Internet Protocol address for use in communication on the mesh from the association response. Some aspects of the method also include generating the authentication request to indicate at least a portion of a proposed Internet Protocol address for use by the non-member device in communication on the mesh network.

Another aspect disclosed is an apparatus for associating with a peer on a mesh network. The apparatus includes an input device, configured to receive a password, a processor, configured to generate an authentication request based on the password, a transmitter, configured to transmit the authentication request to a member device of the mesh network, a receiver, configured to receive an authentication response from the member device. The processor is further configured to generate an association request based on the authentication response and the password, the transmitter is further configured to transmit the association request to the member device, and the receiver is further configured to receive an association response from the member device.

In some aspects of the apparatus, the processor is further configured to generate a pairwise master key (PMK) based on the authentication response, decode a nonce from the authentication response, generate a pairwise transient key (PTK) based on the pairwise master key (PMK), and the nonce; and generate the association request based on the pairwise transient key. In some aspects, the processor is further configured to generate a message integrity code (MIC) based on the pairwise transient key, and generate the association request to indicate the message integrity code. In some aspects, the processor is further configured to assign an association identifier to the member device, and further generate the association request to indicate the association identifier of the member device. In some aspects, the processor is further configured to decode the association response to determine an association identifier, generate a mesh-message to comprise the association identifier, and wherein the transmitter is further configured to transmit the mesh message to the member device.

In some aspects, the processor is further configured to generate a first message integrity code (MIC) based on the password, decode the association response to determine a second message identity code (MIC), compare the first message integrity code to the second message integrity code; and determine whether the non-member device is associated with the member device based on the comparison. In some aspects, the processor is further configured to decode a group key from the association response, the receiver is further configured to receive a mesh message from a second non-member device, and the processor is further configured to decode the mesh message based on the group key.

In some aspects, the processor is further configured to decode a group key from the association response, generate a path request message to comprise a sequence number, encrypt the path request message based on the group key, and wherein the transmitter is further configured to transmit the encrypted path request message on the mesh network. In some aspects, the transmitter is further configured to receive a path response message from a second member device of the mesh, and wherein the processor is further configured to decode the path response message based on the group key, decode the sequence number from the decoded path response message, and associate with the second member device based on the decoded path response message. In some aspects, the processor is further configured to decode an Internet Protocol address for use in communication on the mesh from the association response. In some aspects, the processor is further configured to generate the authentication request to indicate at least a portion of a proposed Internet Protocol address for use by the non-member device in communication on the mesh network.

Another aspect disclosed is a computer readable storage medium comprising instructions that when executed cause a processor to perform a method of peer association in a mesh network, the method comprising receiving, via a non-member device of the mesh network, a password, transmitting, via the non-member device, an authentication request to a member device of the mesh network, the authentication request based on the password, receiving, via the non-member device, an authentication response from the member device, transmitting, via the non-member device, an association request to the member device based on the authentication response, the association request further based on the password; and receiving, via the non-member device, an association response from the member device.

Some aspects of the method also include generating a pairwise master key (PMK) based on the authentication response, decoding a nonce from the authentication response, generating a pairwise transient key (PTK) based on the pairwise master key (PMK), and the nonce; and generating the association request based on the pairwise transient key. Some aspects of the method also include generating a message integrity code (MIC) based on the pairwise transient key; and generating the association request to indicate the message integrity code. Some aspects of the method also include assigning an association identifier to the member device; and further generating the association request to indicate the association identifier of the member device. Some aspects of the method also include decoding an association identifier from the association response, generating a mesh message to comprise the association identifier; and transmitting the mesh message to the member device.

Some aspects of the method also include generating a first message integrity code (MIC) based on the password, decoding the association response to determine a second message integrity code (MIC), comparing the first message integrity code (MIC) to the second message integrity code (MIC); and determining whether the non-member device is associated with the member device based on the comparison. Some aspects of the method also include decoding a group key from the association response, receiving a mesh message from a second non-member device; and decoding the mesh message based on the group key. Some aspects of the method also include decoding a group key from the association response, generating a path request message to comprise a sequence number, encrypting the path request message based on the group key, and transmitting the encrypted path request message on the mesh network.

Some aspects of the method also include receiving a path response message from a second member device of the mesh, decoding the path response message based on the group key, decoding the sequence number from the decoded path response message; and associating with the second member device based on the decoded path response. Some aspects of the method also include decoding an Internet Protocol address for use in communication on the mesh from the association response. Some aspects of the method also include generating the authentication request to indicate at least a portion of a proposed Internet Protocol address for use by the non-member device in communication on the mesh network.

Another aspect disclosed is an apparatus to perform a method of peer association in a mesh network, the apparatus comprising means for receiving a password, means for transmitting an authentication request to a member device of the mesh network, the authentication request based on the password, means for receiving an authentication response from the member device, means for transmitting an association request to the member device based on the authentication response, the association request further based on the password; and means for receiving an association response from the member device.

Some aspects of the apparatus also include means for generating a pairwise master key (PMK) based on the authentication response, means for decoding a nonce from the authentication response, means for generating a pairwise transient key (PTK) based on the pairwise master key (PMK), and the nonce; and means for generating the association request based on the pairwise transient key. Some aspects of the apparatus also include means for generating a message integrity code (MIC) based on the pairwise transient key; and means for generating the association request to indicate the message integrity code. Some aspects of the apparatus also include means for assigning an association identifier to the member device; and means for further generating the association request to indicate the association identifier of the member device. Some aspects of the apparatus also include means for decoding an association identifier from the association response, means for generating a mesh message to comprise the association identifier; and means for transmitting the mesh message to the member device.

Some aspects of the apparatus also include means for generating a first message integrity code (MIC) based on the password, means for decoding the association response to determine a second message integrity code (MIC), means for comparing the first message integrity code (MIC) to the second message integrity code (MIC); and means for determining whether the non-member device is associated with the member device based on the comparison. Some aspects of the apparatus also include means for decoding a group key from the association response, means for receiving a mesh message from a second non-member device; and decoding the mesh message based on the group key. Some aspects of the apparatus also include means for decoding a group key from the association response, means for generating a path request message to comprise a sequence number, means for encrypting the path request message based on the group key, and means for transmitting the encrypted path request message on the mesh network.

Some aspects of the apparatus also include means for receiving a path response message from a second member device of the mesh, means for decoding the path response message based on the group key, means for decoding the sequence number from the decoded path response message; and means for associating with the second member device based on the decoded path response. Some aspects of the apparatus also include means for decoding an Internet Protocol address for use in communication on the mesh from the association response. Some aspects of the apparatus also include means for generating the authentication request to indicate at least a portion of a proposed Internet Protocol address for use by the non-member device in communication on the mesh network.

Another aspect disclosed is a method of associating with a non-member device of a mesh network. The method includes receiving, via a member device, a password, receiving, via the member device of the mesh network, an authentication request, transmitting, via the member device, an authentication response to the non-member device, the authentication response based on the password, receiving, via the member device, an association request from the non-member device; and transmitting, via the member device, an association response to the non-member device, the association response based on the password. In some aspects the method includes decoding a nonce from the authentication request, generating a pairwise master key (PMK) based on the authentication request, generating a pairwise transient key (PTK) based on the pairwise master key (PMK) and the nonce, and generating the association response based on the pairwise transient key. In some aspects the method includes generating a message integrity code (MIC) based on the pairwise transient key, and generating the association response to indicate the message integrity code. In some aspects the method includes assigning an association identifier to the non-member device; and further generating the association response to indicate the association identifier of the non-member device. In some aspects, the method includes decoding the association request to determine an association identifier, generating a mesh message to comprise the association identifier; and transmitting the mesh message to the non-member device.

In some aspects the method includes generating a first message integrity code (MIC) based on the password, decoding the association request to determine a second message integrity code (MIC), comparing the first message integrity code (MIC) to the second message integrity code (MIC); and determining whether the non-member device is associated with the member device based on the comparison. In some aspects, the method includes generating the association response to include a group key for the mesh network, receiving a message from the mesh network; and decoding the message based on the group key. In some aspects, the method includes decoding an Internet Protocol address for use in communication with the non-member device from the association request. In some aspects, the method includes generating the authentication response to indicate at least a portion of a proposed Internet Protocol address for use by the member device in communication with the non-member device on the mesh network.

Another aspect disclosed is an apparatus for associating with a non-member device of a mesh network. The apparatus includes a processor configured to receive a password, a receiver configured to receive an authentication request from the non-member device, a transmitter configured to transmit an authentication response to the non-member device, the authentication response based on the password. The receiver is further configured to receive an association request from the non-member device, and the transmitter is further configured to transmit an association response to the non-member device, the association response based on the password. In some aspects, the processor is further configured to decode a nonce from the authentication request, generate a pairwise master key (PMK) based on the authentication request, generate a pairwise transient key (PTK) based on the pairwise master key (PMK) and the nonce, and generate the association response based on the pairwise transient key. In some aspects, the processor is further configured to generate a message integrity code (MIC) based on the pairwise transient key; and generate the association response to indicate the message integrity code. In some aspects, the processor is further configured to assign an association identifier to the non-member device; and further generate the association response to indicate the association identifier of the non-member device. In some aspects, the processor is further configured to generate a first message integrity code (MIC) based on the password, decode the association request to determine a second message integrity code (MIC), compare the first message integrity code (MIC) to the second message integrity code (MIC), and determine whether the non-member device is associated with the member device based on the comparison.

In some aspects, of the apparatus, the processor is further configured to generate the association response to include a group key for the mesh network, the receiver is further configured to receive a message from the mesh network; and the processor is further configured to decode the message based on the group key.

In some aspects, the processor is further configured to decode the association request to determine an association identifier, generate a mesh-message to comprise the association identifier, and wherein the transmitter is further configured to transmit the mesh message to the non-member device. In some aspects, the processor is further configured to decode an Internet Protocol address for use in communication with the non-member device from the association request. In some aspects, the processor is further configured to generate the authentication response to indicate at least a portion of a proposed Internet Protocol address for use by the member device in communication with the non-member device on the mesh network.

Another aspect disclosed is an apparatus for associating with a non-member device of a mesh network. The apparatus includes means for receiving a password, means for receiving an authentication request, means for transmitting an authentication response to the non-member device, the authentication response based on the password, means for receiving an association request from the non-member device; and means for transmitting an association response to the non-member device, the association response based on the password. In some aspects the apparatus includes means for decoding a nonce from the authentication request, means for generating a pairwise master key (PMK) based on the authentication request, means for generating a pairwise transient key (PTK) based on the pairwise master key (PMK) and the nonce, and means for generating the association response based on the pairwise transient key. In some aspects the apparatus includes means for generating a message integrity code (MIC) based on the pairwise transient key, and means for generating the association response to indicate the message integrity code. In some aspects the apparatus includes means for assigning an association identifier to the non-member device; and further means for generating the association response to indicate the association identifier of the non-member device. In some aspects, the apparatus includes means for decoding the association request to determine an association identifier, means for generating a mesh message to comprise the association identifier; and means for transmitting the mesh message to the non-member device.

In some aspects the apparatus includes means for generating a first message integrity code (MIC) based on the password, means for decoding the association request to determine a second message integrity code (MIC), means for comparing the first message integrity code (MIC) to the second message integrity code (MIC); and means for determining whether the non-member device is associated with the member device based on the comparison. In some aspects, the apparatus includes means for generating the association response to include a group key for the mesh network, means for receiving a group-addressed message from the mesh network; and means for decoding the group-addressed message based on the group key. In some aspects, the apparatus includes means for decoding an Internet Protocol address for use in communication with the non-member device from the association request. In some aspects, the method includes means for generating the authentication response to indicate at least a portion of a proposed Internet Protocol address for use by the member device in communication with the non-member device on the mesh network.

Another aspect disclosed is a computer readable storage medium comprising instructions that when executed cause a processor to perform a method of associating with a non-member device of a mesh network. The method includes receiving, via a member device, a password, receiving, via the member device of the mesh network, an authentication request, transmitting, via the member device, an authentication response to the non-member device, the authentication response based on the password, receiving, via the member device, an association request from the non-member device; and transmitting, via the member device, an association response to the non-member device, the association response based on the password. In some aspects the method includes decoding a nonce from the authentication request. generating a pairwise master key (PMK) based on the authentication request, generating a pairwise transient key (PTK) based on the pairwise master key (PMK) and the nonce, and generating the association response based on the pairwise transient key. In some aspects the method includes generating a message integrity code (MIC) based on the pairwise transient key, and generating the association response to indicate the message integrity code. In some aspects the method includes assigning an association identifier to the non-member device; and further generating the association response to indicate the association identifier of the non-member device. In some aspects, the method includes decoding the association request to determine an association identifier, generating a mesh message to comprise the association identifier; and transmitting the mesh message to the non-member device.

In some aspects the method includes generating a first message integrity code (MIC) based on the password, decoding the association request to determine a second message integrity code (MIC), comparing the first message integrity code (MIC) to the second message integrity code (MIC); and determining whether the non-member device is associated with the member device based on the comparison. In some aspects, the method includes generating the association response to include a group key for the mesh network, receiving a message from the mesh network; and decoding the message based on the group key. In some aspects, the method includes decoding an Internet Protocol address for use in communication with the non-member device from the association request. In some aspects, the method includes generating the authentication response to indicate at least a portion of a proposed Internet Protocol address for use by the member device in communication with the non-member device on the mesh network.

One aspect disclosed is a method of establishing a secure connection with a mesh peer device. The method includes receiving a peer link open message from the mesh peer device, decoding the peer link open message to determine a peer commit scalar for the mesh peer device, decoding the peer link open message to determine a peer commit element for the mesh peer device, determining a security key identifier based on the peer commit scalar and the peer commit element; and communicating with the mesh peer device based on the security key identifier.

In some aspects, the method further includes generating a commit scalar, generating a commit element, and transmitting a peer link open message, the peer link open message indicating the commit scalar and the commit element. In some aspects, determining the security key identifier is further based on the commit scalar and the commit element.

In some aspects, the method includes receiving a peer link confirm message, the peer link confirm message indicating a peer confirmation identifier, validating the security key identifier based on the peer confirmation identifier, and determining whether to communicate with the mesh peer device based on the validation.

In some aspects, the method includes generating a confirmation identifier based on the commit scalar and the commit element, generating a peer link confirm message indicating the confirmation identifier, and transmitting the peer link confirm message to the mesh peer device.

In some aspects, the method includes decoding the peer link open message to determine at least a portion of a proposed Internet Protocol (IP) address for the mesh peer device, determining an Internet Protocol address to assign to the mesh peer device based at least in part on the portion of the proposed Internet Protocol address for the mesh peer device, generating a peer link confirm message indicating an Internet Protocol Address assigned to the mesh peer device, and transmitting the peer link confirm message to the mesh peer device.

In some aspects, the method further includes determining whether the proposed Internet Protocol address is in use by another device, wherein the Internet Protocol address assigned to the mesh peer device is based at least in part on the determination. In some aspects, the method further includes receiving a service discovery message from the mesh peer device, wherein the peer link open message is transmitted to the mesh peer device based on the service discovery message. In some aspects, the method further includes receiving the service discovery message comprises receiving a service advertisement message. In some aspects, the method also includes decoding the peer link open message to determine one or more devices that the mesh peer device is peered with.

Some aspects of the method further include decoding the peer link open message to determine a mesh profile of the mesh peer device; decoding the mesh profile to determine whether a value for one or more of an extended supported rates element, a power capability element, a supported channels element, a supported regulatory classes element, a high throughput capabilities element, a high throughput operations element, a 20/40 basic service set coexistence element, an extended capabilities element or an internetwork element are specified in the mesh profile; and associating a corresponding default value with one or more unspecified elements of the mesh profile based on the determination.

Another aspect disclosed is an apparatus for establishing a secure connection with a mesh peer device. The apparatus includes a processing system configured to receive a peer link open message from the mesh peer device, decode the peer link open message to determine a peer commit scalar for the mesh peer device, decode the peer link open message to determine a peer commit element for the mesh peer device, determine a security key identifier based on the peer commit scalar and the peer commit element; and communicate with the mesh peer device based on the security key identifier.

In some aspects of the apparatus, the processing system is further configured to: generate a commit scalar, generate a commit element; and transmit a peer link open message, the peer link open message indicating the commit scalar and the commit element.

In some aspects of the apparatus, determining the security key identifier is further based on the commit scalar and the commit element. In some aspects, the processing system is further configured to receive a peer link confirm message, the peer link confirm message indicating a peer confirmation identifier, validate the security key identifier based on the peer confirmation identifier, and determine whether to communicate with the mesh peer device based on the validation.

In some aspects of the apparatus, the processing system is further configured to generate a confirmation identifier based on the commit scalar and the commit element, generate a peer link confirm message indicating the confirmation identifier, and transmit the peer link confirm message to the mesh peer device. In some aspects, the processing system is further configured to decode the peer link open message to determine at least a portion of a proposed Internet Protocol (IP) address for the mesh peer device, determine an Internet Protocol address to assign to the mesh peer device based at least in part on the at least a portion of the proposed Internet Protocol address for the mesh peer device, generate a peer link confirm message indicating an Internet Protocol Address assigned to the mesh peer device, and transmit the peer link confirm message to the mesh peer device.

In some aspects of the apparatus, the processing system is further configured to determine whether the proposed Internet Protocol address is in use by another device, wherein the Internet Protocol address assigned to the mesh peer device is based at least in part on the determination. In some aspects of the apparatus, the processing system is further configured to receive a service discovery message from the mesh peer device, wherein the peer link open message is transmitted to the mesh peer device based on the service discovery message. In some aspects, receiving the service discovery message comprises receiving a service advertisement message.

In some aspects, of the apparatus, the processing system is further configured to decode the peer link open message to determine one or more devices that the mesh peer device is peered with. In some aspects of the apparatus, the processing system is further configured to: decode the peer link open message to determine a mesh profile of the mesh peer device; decode the mesh profile to determine whether a value for one or more of an extended supported rates element, a power capability element, a supported channels element, a supported regulatory classes element, a high throughput capabilities element, a high throughput operations element, a 20/40 basic service set coexistence element, an extended capabilities element or an internetwork element are specified in the mesh profile; and associate a corresponding default value with one or more unspecified elements of the mesh profile based on the determination.

Another aspect disclosed is an apparatus for establishing a secure connection with a mesh peer device. The apparatus includes means for receiving a peer link open message from the mesh peer device, means for decoding the peer link open message to determine a peer commit scalar for the mesh peer device; means for decoding the peer link open message to determine a peer commit element for the mesh peer device, means for determining a security key identifier based on the peer commit scalar and the peer commit element, and means for communicating with the mesh peer device based on the security key identifier.

In some aspects, the apparatus further includes means for generating a commit scalar, means for generating a commit element, and means for transmitting a peer link open message, the peer link open message indicating the commit scalar and the commit element.

In some aspects, determining the security key identifier is further based on the commit scalar and the commit element. In some aspects, the apparatus further includes means for receiving a peer link confirm message, the peer link confirm message indicating a peer confirmation identifier, means for validating the security key identifier based on the peer confirmation identifier, and means for determining whether to communicate with the mesh peer device based on the validation.

In some aspects, the apparatus further includes means for generating a confirmation identifier based on the commit scalar and the commit element, means for generating a peer link confirm message indicating the confirmation identifier; and means for transmitting the peer link confirm message to the mesh peer device. In some aspects, the apparatus further includes means for decoding the peer link open message to determine at least a portion of a proposed Internet Protocol (IP) address for the mesh peer device. means for determining an Internet Protocol address to assign to the mesh peer device based at least in part on the at least a portion of the proposed Internet Protocol address for the mesh peer device, means for generating a peer link confirm message indicating an Internet Protocol Address assigned to the mesh peer device, and means for transmitting the peer link confirm message to the mesh peer device.

In some aspects, the apparatus further includes means for determining whether the proposed Internet Protocol address is in use by another device, wherein the Internet Protocol address assigned to the mesh peer device is based at least in part on the determination.

In some aspects, the apparatus further includes means for receiving a service discovery message from the mesh peer device, wherein the peer link open message is transmitted to the mesh peer device based on the service discovery message. In some aspects, receiving the service discovery message comprises receiving a service advertisement message. In some aspects, the apparatus further includes means for decoding the peer link open message to determine one or more devices that the mesh peer device is peered with.

In some aspects, the apparatus further includes means for decoding the peer link open message to determine a mesh profile of the mesh peer device; means for decoding the mesh profile to determine whether a value for one or more of an extended supported rates element, a power capability element, a supported channels element, a supported regulatory classes element, a high throughput capabilities element, a high throughput operations element, a 20/40 basic service set coexistence element, an extended capabilities element or an internetwork element are specified in the mesh profile, and means for associating a corresponding default value with one or more unspecified elements of the mesh profile based on the determination.

Another aspect disclosed is a computer readable storage medium comprising instructions that when executed cause a processing system to perform a method of establishing a secure connection with a mesh peer device. The method includes The method includes receiving a peer link open message from the mesh peer device, decoding the peer link open message to determine a peer commit scalar for the mesh peer device, decoding the peer link open message to determine a peer commit element for the mesh peer device, determining a security key identifier based on the peer commit scalar and the peer commit element; and communicating with the mesh peer device based on the security key identifier.

In some aspects, the method further includes generating a commit scalar, generating a commit element, and transmitting a peer link open message, the peer link open message indicating the commit scalar and the commit element. In some aspects, determining the security key identifier is further based on the commit scalar and the commit element.

In some aspects, the method includes receiving a peer link confirm message, the peer link confirm message indicating a peer confirmation identifier, validating the security key identifier based on the peer confirmation identifier, and determining whether to communicate with the mesh peer device based on the validation.

In some aspects, the method includes generating a confirmation identifier based on the commit scalar and the commit element, generating a peer link confirm message indicating the confirmation identifier, and transmitting the peer link confirm message to the mesh peer device.

In some aspects, the method includes decoding the peer link open message to determine at least a portion of a proposed Internet Protocol (IP) address for the mesh peer device, determining an Internet Protocol address to assign to the mesh peer device based at least in part on the portion of the proposed Internet Protocol address for the mesh peer device, generating a peer link confirm message indicating an Internet Protocol Address assigned to the mesh peer device, and transmitting the peer link confirm message to the mesh peer device.

In some aspects, the method further includes determining whether the proposed Internet Protocol address is in use by another device, wherein the Internet Protocol address assigned to the mesh peer device is based at least in part on the determination. In some aspects, the method further includes receiving a service discovery message from the mesh peer device, wherein the peer link open message is transmitted to the mesh peer device based on the service discovery message. In some aspects, the method further includes receiving the service discovery message comprises receiving a service advertisement message. In some aspects, the method also includes decoding the peer link open message to determine one or more devices that the mesh peer device is peered with.

Some aspects of the method further include decoding the peer link open message to determine a mesh profile of the mesh peer device; decoding the mesh profile to determine whether a value for one or more of an extended supported rates element, a power capability element, a supported channels element, a supported regulatory classes element, a high throughput capabilities element, a high throughput operations element, a 20/40 basic service set coexistence element, an extended capabilities element or an internetwork element are specified in the mesh profile; and associating a corresponding default value with one or more unspecified elements of the mesh profile based on the determination.

### BRIEF DESCRIPTION OF THE DRAWINGS

FIG. 1 illustrates an example of a neighbor aware network (NAN).

FIG. 2 illustrates a illustrative embodiment of a wireless device of one or more of the mobile devices of FIG. 1.

FIG. 3 is a message flow diagram of a mesh peering process over a NAN network.

FIG. 4 is an example message format for a management frame.

FIG. 5 is a table indicating various example combinations of values for the type field and subtype field of FIG. 4.

FIG. 6A shows an example message body for an authentication message.

FIG. 6B shows an example format of an IP address request information element.

FIG. 6C shows an example format of an IP address data field.

FIG. 6D shows an example of an IP address request control field.

FIG. 6E shows an example format of a High Level Protocol (HLP) Container element.

FIG. 7A shows an example message body of an association request message.

FIG. 7B shows one example format of a FILS Key Confirmation element.

FIG. 8 shows an example IP address assignment information element.

FIG. 9 shows an example message body of an association response message.

FIG. 10 shows one example of a method for efficient mesh peering with a mesh peer device on the neighbor aware network of FIG. 1.

FIG. 11 shows one example of a method for efficient mesh peering with a mesh peer device on the neighbor aware network of FIG. 1.

FIG. 12 shows one example of a method for efficient mesh peering with a mesh peer device on the neighbor aware network of FIG. 1.

### DETAILED DESCRIPTION

Various aspects of the novel systems, apparatuses, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Popular wireless network technologies may include various types of wireless local area networks (WLANs). A WLAN may be used to interconnect nearby devices together, employing widely used networking protocols. The various aspects described herein may apply to any communication standard, such as a wireless protocol.

In some aspects, wireless signals in a sub-gigahertz band may be transmitted according to the 802.11ah protocol or the 802.11ac protocol using orthogonal frequency-division multiplexing (OFDM), direct-sequence spread spectrum (DSSS) communications, a combination of OFDM and DSSS communications, or other schemes. Implementations of the 802.11ah protocol or the 802.11ac protocol may be used for sensors, metering, and smart grid networks. Advantageously, aspects of certain devices implementing the 802.11ah protocol or the 802.11ac protocol may consume less power than devices implementing other wireless protocols, and/or may be used to transmit wireless signals across a relatively long range, for example about one kilometer or longer.

In some implementations, a WLAN includes various devices which are the components that access the wireless network. For example, there may be two types of devices: access points (“APs”) and clients (also referred to as stations, or “STAs”). In general, an AP may serve as a hub or base station for the WLAN and an STA serves as a user of the WLAN. For example, an STA may be a laptop computer, a personal digital assistant (PDA), a mobile phone, etc. In an example, an STA connects to an AP via a WiFi (e.g., IEEE 802.11 protocol such as 802.11ah or 802.11ac) compliant wireless link to obtain general connectivity to the Internet or to other wide area networks. In some implementations an STA may also be used as an AP.

An access point (“AP”) may also comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, or some other terminology.

A station “STA” may also comprise, be implemented as, or known as an access terminal (“AT”), a subscriber station, a subscriber unit, a mobile station, a remote station, a remote terminal, a user terminal, a user agent, a user device, user equipment, or some other terminology. In some implementations an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

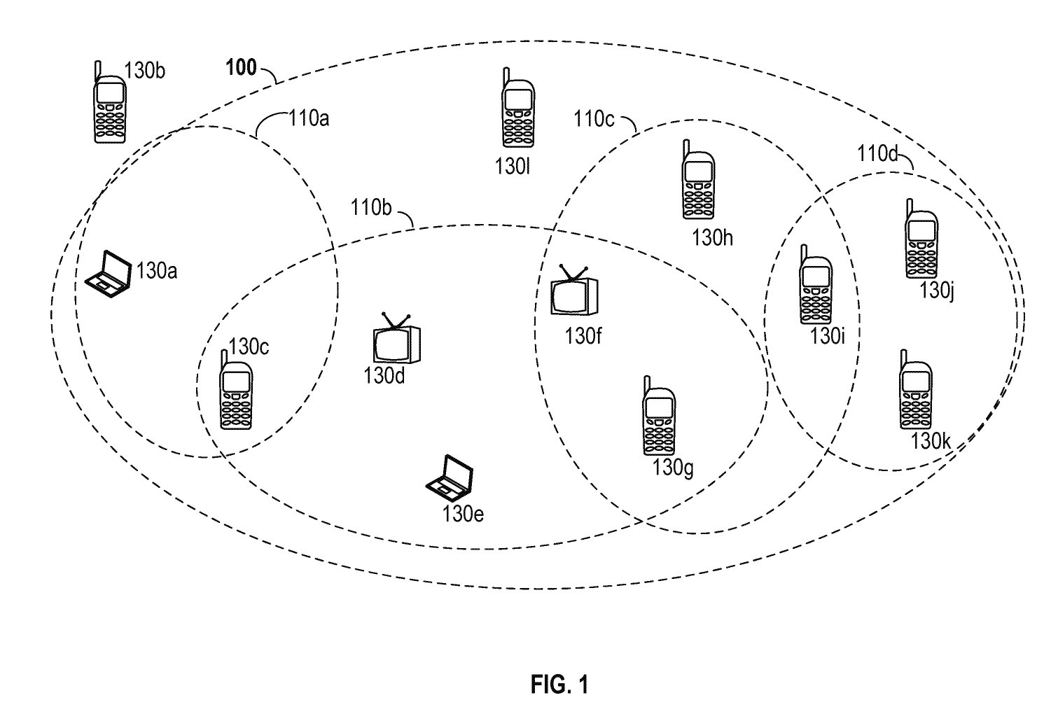

Referring to FIG. 1, a particular illustrative embodiment of a wireless network is depicted and generally designated 100. In some aspects, the wireless network 100 is a neighbor aware network or NAN. A NAN may also be referred to as an ad-hoc network in this disclosure. FIG. 1 illustrates that all the wireless devices 130a-1 except device 130b are participating in the wireless network 100. For example, each of devices 130a and 130c-1 receives beacon or other time synchronization information from the wireless network 100. In one aspect, one of wireless devices 130a and 130c-1 may be designated as a “root” node for the wireless network 100, and therefore periodically transmit synchronization messages that are received by each of the other devices 130a and 130c-1. In some aspects, a portion of communication that occurs on the wireless network 100 may be performed on a standard communication channel, for example, channel 6 in some aspects. In some aspects, one or more of the wireless devices 130a and 130c-1 may be considered stations.

The wireless network 100 also includes four service mesh networks 110a-110d. Each of service mesh networks 110a-110d is shown including a portion of the wireless devices 130a and 130c-k. Service mesh network 110a includes wireless devices 130a and 130c. Service mesh network 110b includes wireless devices 130c-g. Service mesh network 110c includes wireless devices 130f-i. Service mesh network 110d includes wireless devices 130i-k. Wireless device 130b is not included in any of service mesh networks 110a-d. Using the methods, systems and computer readable mediums disclosed herein, the non-member device 130b may become a member of one or more of the networks shown in FIG. 1. For example, device 130b may become a member of service mesh network 110a.

Each service mesh network 110a-d may be utilized by a service providing device to provide a service to other members of the service mesh network. For example, wireless device 130a may be a service providing device for mesh 110a, which, in one example, provides a music service to wireless devices 130b-c. Mobile device 130a may advertise the service being provided on service mesh network 110a to devices on wireless network 100. For example, mobile device 130a (or other service providing devices on wireless network 100) may broadcast or multicast a message over the wireless network 100 indicating a service that can be provided and one or more parameters associated with obtaining the service. In addition, a service providing device on wireless network 100 may respond to service discovery requests received from wireless network 100 as described above. For example, service providing device 130a may transmit a discovery response that includes information indicating the service being provided on service mesh network 110a.

Similarly, each of service mesh networks 110b-d also include a service providing device that may operate similarly to the example of device 130a provided above. For example, mobile device 130d may be a service providing device for service mesh network 110b, offering a video game service to mobile devices 130c, 130e, 130f, and 130g. Mobile device 130h may be a service providing device for service mesh network 110c by providing a picture sharing service to mobile devices 130f, 130g, and 130i. Similarly, mobile device 110j may provide a video service over service mesh network 110d to mobile devices 130i and 130k.

A mobile device may be a member of two or more service mesh networks concurrently and therefore receive services provided by each of the service providing devices of the respective service mesh networks. For example, mobile device 130c is shown as a member of both service mesh networks 110a and 110b. Thus, mobile device 130c may be concurrently receiving the music services provided by mobile device 130a and image services provided by mobile device 130d. Similarly, mobile devices 130f-g participate in service mesh networks 110b and 110c, and mobile device 130i participates in both service mesh networks 110c and 110d.

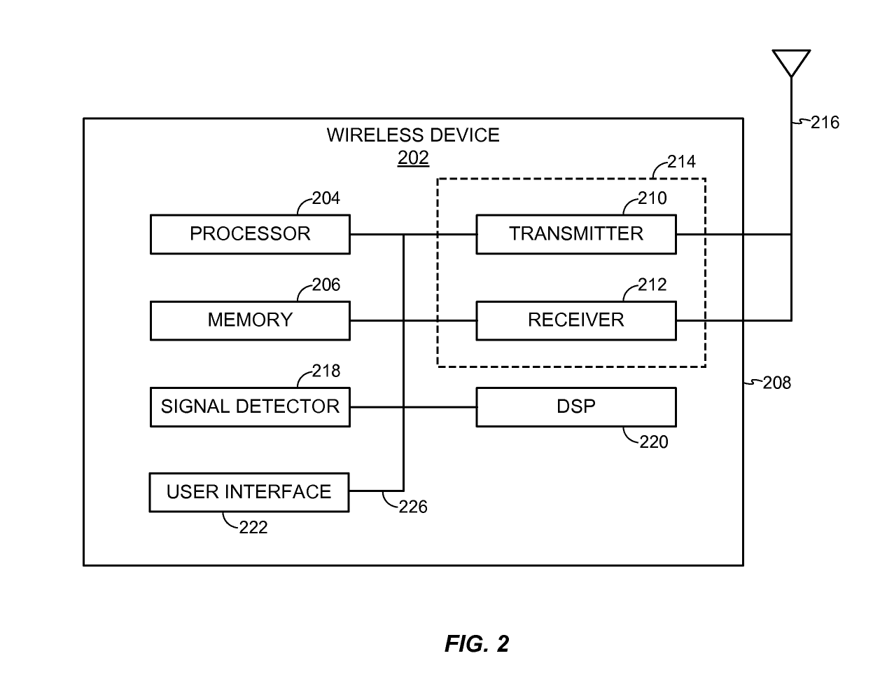

FIG. 2 shows an exemplary functional block diagram of a wireless device 202 that may be employed within the wireless network 100 of FIG. 1. The wireless device 202 is an example of a device that may be configured to implement the various methods described herein. For example, the wireless device 202 may comprise one of the stations 130a-1.

The wireless device 202 may include a processor 204 which controls operation of the wireless device 202. The processor 204 may also be referred to as a central processing unit (CPU). Memory 206, which may include both read-only memory (ROM) and random access memory (RAM), may provide instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The processor 204 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 202 may also include a housing 208 that may include a transmitter 210 and/or a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas.

The wireless device 202 may also include a signal detector 218 that may be used in an effort to detect and quantify the level of signals received by the transceiver 214. The signal detector 218 may detect such signals as total energy, energy per subcarrier per symbol, power spectral density and other signals. The wireless device 202 may also include a digital signal processor (DSP) 220 for use in processing signals. The DSP 220 may be configured to generate a packet for transmission. In some aspects, the packet may comprise a physical layer data unit (PPDU).

The wireless device 202 may further comprise a user interface 222 in some aspects. The user interface 222 may comprise a keypad, a microphone, a speaker, and/or a display. The user interface 222 may include any element or component that conveys information to a user of the wireless device 202 and/or receives input from the user.

The various components of the wireless device 202 may be coupled together by a bus system 226. The bus system 226 may include a data bus, for example, as well as a power bus, a control signal bus, and a status signal bus in addition to the data bus. Those of skill in the art will appreciate the components of the wireless device 202 may be coupled together or accept or provide inputs to each other using some other mechanism.

Although a number of separate components are illustrated in FIG. 2, those of skill in the art will recognize that one or more of the components may be combined or commonly implemented. For example, the processor 204 may be used to implement not only the functionality described above with respect to the processor 204, but also to implement the functionality described above with respect to the signal detector 218 and/or the DSP 220. Further, each of the components illustrated in FIG. 2 may be implemented using a plurality of separate elements.

The wireless device 202 may comprise any of wireless devices 130a-1, and may be used to transmit and/or receive communications. That is, any of wireless devices 130a-1 may serve as transmitter or receiver devices. Certain aspects contemplate signal detector 218 being used by software running on memory 206 and processor 204 to detect the presence of a transmitter or receiver.

As described above, a wireless device, such as wireless device 202, may be configured to provide services within a wireless communication system, such as the wireless communication system 100. For example, the wireless device 202 may include hardware (e.g., a sensor, a global positioning system (GPS), etc.) that is used to capture or calculate data (e.g., sensor measurements, location coordinates, etc.).

The disclosed methods and systems provide for improved efficiency of mesh communications when compared to known methods and systems. For example, the disclosed methods and systems may provide for secure mesh communication to be established between two mesh devices with the exchange of four (4) messages. In some aspects, a negotiation of IP addresses for use in mesh communication, along with the establishment of mesh communication between two mesh peer devices, may also be established with the exchange of a total of four (4) messages. In some aspects, these two features are combined, such that negotiation/assignment of IP addresses, and secure mesh communications are established between two mesh peer devices with the exchange of four messages. This may provide for lower latency in the establishment of mesh communications, along with reduced computational overhead in devices participating in a mesh.

The present disclosure is directed to methods and systems that provide for an integrated authentication and association process. This integrated process provides mesh association using a four way message exchange between a mesh member device and a non-member device. Use of a common group key in these methods and systems facilitates encryption and decryption of group addressed mesh messages transmitted and/or received to/from any mesh member device. Some aspects may also encrypt and/or decrypt unicast packets using the common group key.

These disclosed methods and systems greatly simplify mesh communication when compared to known methods and systems that utilize separate group keys for the transmissions of each mesh member device.

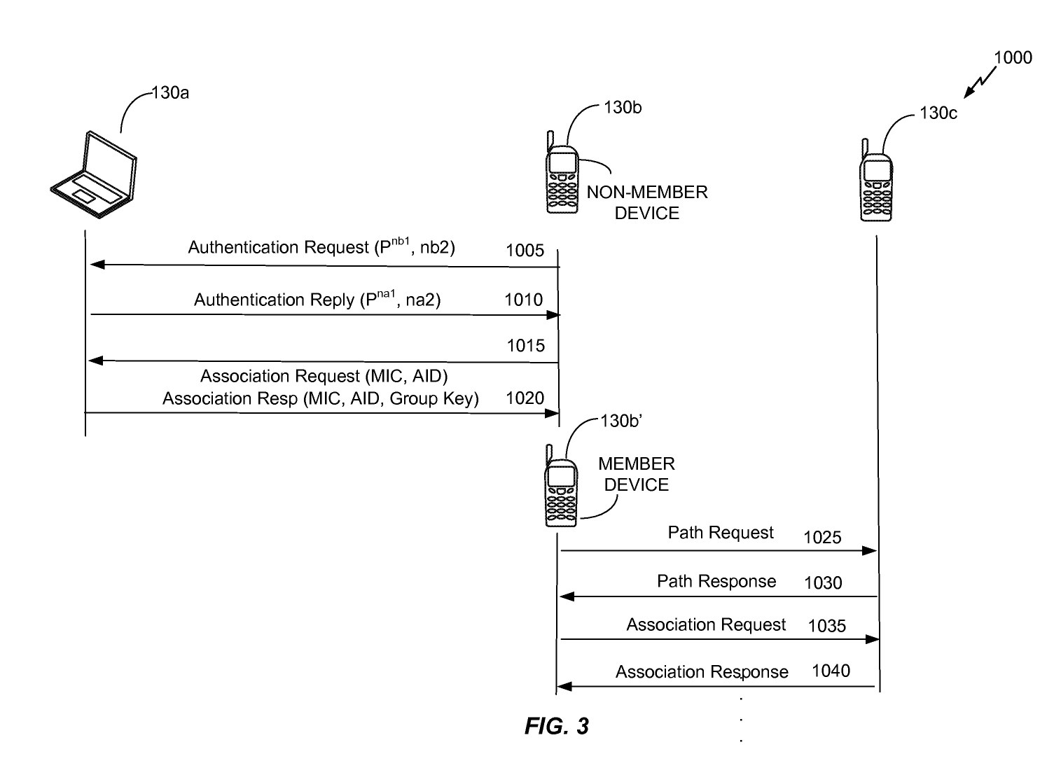

Referring to FIG. 3, a message flow diagram of a mesh peering process over a NAN network is shown and generally designated 1000. FIG. 3 illustrates three devices 130a-c performing a mesh peering process in one example embodiment. Before the illustrated message flow begins, devices 130a and 130c are already members of a mesh network. As discussed above, the mesh network utilizes a common group key to encrypt and/or decrypt group addressed messages exchanged between member devices of the mesh.

The devices 130a-c may share a common password that facilitates secure communication between them. In some aspects, the common password may be independently entered via an input interface of each of the devices 130a-c. In some aspects, one or more of the devices 130a-c may create a password element (P) using the common password. In some aspects, a password element (P) used for communication between the STAs 106a-c may be determined in the same manner as is used in SAE Authentication.

One or more of each of devices 130a-c may also (in some aspects, randomly) determine two nonces. For example, device 130b may create N_{b1} and N_{b2}. One or more of the devices 130a-c may generate, in some aspects, a Diffie-Hellman (DH) public value based on at least one of their respectively generated nonce values. For example, device 130b may generate, using the password element and N_{b1}, a public value P^{nb1}.

In the illustrated aspect, the device 130b transmits an authentication request message 1005 to device 130a. The authentication request message 1005 includes the P^{nb1} value and N_{b2}. The authentication request message 1005 may also include a proposed IP address (or a portion thereof) for the device 130b to use in mesh communication with device 130a. The authentication request 1005 may be transmitted during a paging window (PW) as advertised on the neighbor aware network (NAN). In some aspects, the authentication request message may share certain characteristics with the 802.11ai fast initial link setup authentication request frame.

The device 130a may perform a similar process as device 130b. The device 130a may create two nonces, Nₐ₁ and Nₐ₂. Because device 130a knows the same password

as device 130b, device 130b also creates a password element based on the shared password. The password element and nonce Nₐ₁ are used to create, in some aspects, a Diffie-Hellman (DH) public value, P^{na1}. Upon receiving the authentication request 1005 from device 130b, device 130a transmits P^{na1} and Nₐ₂ to device 130b in an authentication reply message 1010. The authentication reply message 1010 may also include a proposed IP address for use by device 130a during communication with device 130b. In some aspects, the authentication reply message 1010 may share particular characteristics with an 802.11ai fast initial link setup (FILS) authentication response frame.

After messages 1005 and 1010 have been received by each of device 130a and 130b respectively, each of the two devices 130a-b may generate a pairwise master key (PMK). The pairwise master key may be generated in some aspects in a similar manner as that prescribed by SAE authentication.

After the PMK is generated by device 130b, a pairwise transient key (PTK) is generated based on the PMK. In some aspects, the PTK is based on the PMK, Nₐ₂ and N_{b2}. In some aspects, a PTK is generated in substantial accordance with the method used in 802.11ai authentication.

STA 106b may create a message integrity code (MIC) based on the PTK. STA 106b then transmits an association request message 1015 to the STA 106a. The association request includes the MIC. The STA 106b may also assign an association identifier (AID) to the STA 106a, and include the AID in the association request message 1015. In some aspects, the association request message 1015 may include an IP address assigned by device 106b.to the device 106a for mesh communication with device 106b In some aspects, the association request message 1015 shares one or more characteristics of a fast initial link setup (FILS) association request frame of the 802.11ai protocol. For example, the request message 1015 may be a FILS association request frame modified to include the message integrity code and IP address discussed above. In some aspects, the device 130b includes its PHY and/or MAC capabilities in the association request message 1015.

Upon receiving the association request message 1015, the device 130a may also create a second message integrity code (MIC), and assign its own second association identifier (AID) to the device 130b. The device 130a may include its PHY and/or MAC capabilities in the association response message 1020.

Since the device 130a is already a member of the mesh network, the device 130a also includes a common group key for the mesh in the association response message 1020. This common group key may be used by the device 130b to encrypt and/or decrypt group addressed messages exchanged over the mesh network. Device 130a then transmits an association response message 1020 that includes the second AID and second MIC to the device 130b. The association response message 1020 may share one or more characteristics of a fast initial link setup (FILS) association response message. For example, the association response message 1020 may be a FILS association response message, with modifications necessary to include the MIC, AID, and Group Key as discussed above.

Upon receiving the common group key in message 1020, device 130b may now be able to encrypt and/or decrypt group addressed messages exchanged between devices on the mesh network. Thus, device 130b becomes a member device of the mesh network. This is indicated in FIG. 3 by denoting the device 130b as 130b′ when it has become a member device. For example, device 130b may transmit (unicast or broadcast) a path request message 1025 over the mesh network utilizing the common group key from message 1020 to encrypt the path request message 1025. In some aspects, the path request message may be a path request (PREM) message that is part of a Hybrid Wireless Mesh Protocol (HWMP). The path request message 1025 may include a sequence number field, and the value in the sequence number field may enable device 130b to associate any received path response messages with the path request message. The path request message may be encrypted by the device 130b using the common group key received by device 130b in the association response message 1020.

The path request message 1025 may be received by device 130c, which is also a member of the mesh network, and therefore can successfully decrypt message 1025 (also using the common group key). In some aspects, device 130c may transmit a path response message 1030 as shown. The path response message 1030 may be a HWMP path response message (PREP) in some aspects. The path response message 1030 may include information indicating a path through the mesh network via device 130c. The path response message 1030 may also include a sequence number field. If the path response message 1030 sequence number field has the same value as provided by the device 130b in the path request message 1025, device 130b may understand that the path response message 1030 is in response to the path request message 1025.

Upon receiving the message 1030 and successfully decoding it via the common group key, the device 130b may determine that device 130b provides one or more useful services. Device 130b may then initiate an association via association request 1035 with device 130c. In some aspects, the association request message 1035 may share some or all of the characteristics of association request 1015. Device 130c may then transmit an association response message 140 to device 130b. Once association between devices 130b and 130c is complete, device 130b may transmit one or more service messages over the mesh network using device 130c (not shown).

The above message flow demonstrates several advantages of the methods and systems disclosed. First, non-member devices may join a mesh network (and/or a social WiFi network) by authenticating with only one participating/member device. This is at least partly facilitated via the mesh network's use of a common group key for the encrypting and decrypting of mesh network messages. This common group key is shared with a new device when it joins the mesh, via the association process. In some aspects, PHY/MAC capabilities are also exchanged during the association.

The four way handshake discussed above also establishes an association identifier for each of the member and non-member devices participating in the handshake. These association identifiers are used for message exchange between the two devices. For example, an association identifier may be used during traffic advertisement (TIM messages) during a paging window of the mesh network. In some aspects, IP address assignment is also performed as part of the four way handshake. For example, each of the authentication messages may include proposed IP addresses for the device transmitting the authentication message. The association messages may include an IP address assigned to the devices receiving the association messages.

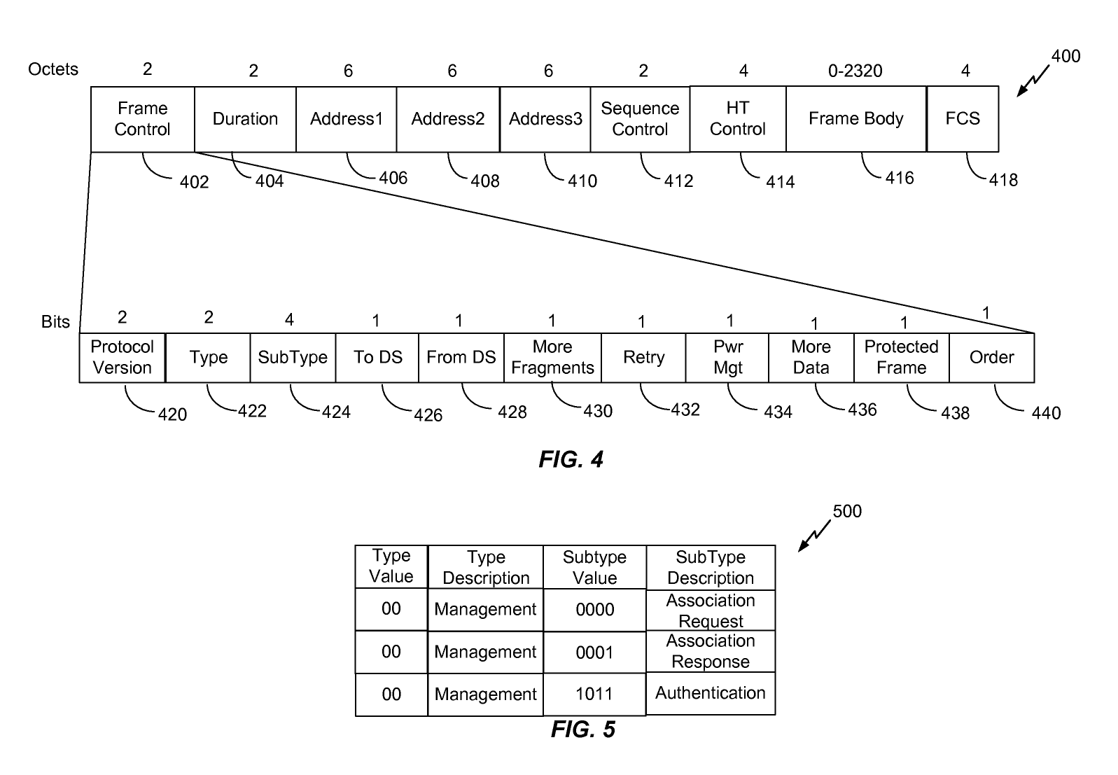

FIG. 4 is an example message format for a management frame. The management frame 400 includes a frame control field 402, duration field 404, first address field 406, second address filed 408, third address field 410, sequence control field 412, high throughput control field 414, frame body 416, and a frame check sequence 418.

The frame control field may include a protocol version field 420, a type field 422, a subtype field 424, a toDS field 426, a fromDS field 428, a more fragments field 430, a retry field 432, a power management field 434, a more data field 436, a protected frame field 438, and an order field 440.

FIG. 5 is a table indicating various example combinations of values for the type field 422 and subtype field 424 of FIG. 4. As shown by FIG. 5, in some aspects, an authentication message, such as the authentication request message 1005 and the authentication response message 1010 of FIG. 3, may have a type value of 00b, indicating a management frame, and a subtype value of 1011b, indicating an authentication message. In some aspects, an association request, such as the association request message 1015 of FIG. 3, may have a type value of 00b, indicating a management frame, and a subtype value of zero (0b). In some aspects, an association response, such as association response message 1020 of FIG. 3, may have a type value of 00b, indicating a management frame, and a subtype value of 0001b, indicating an association response.

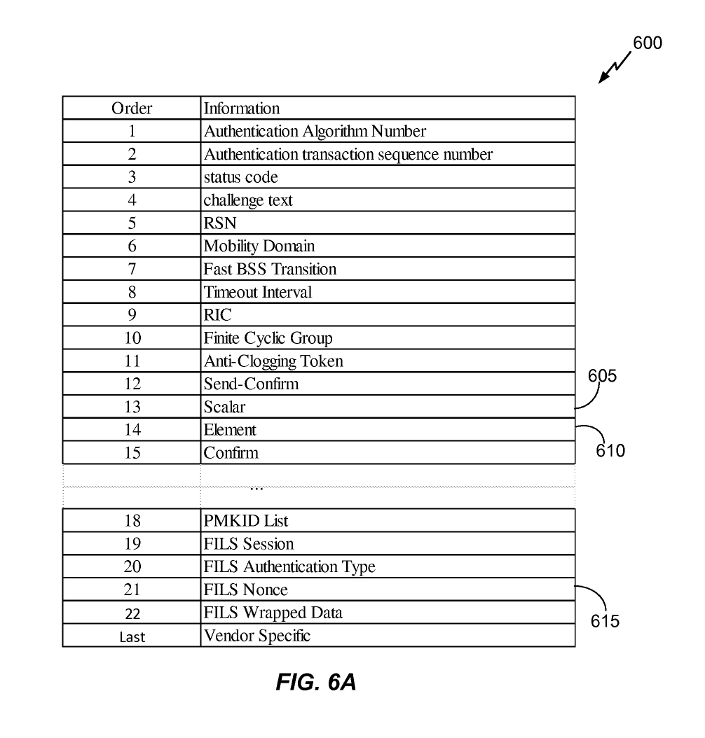

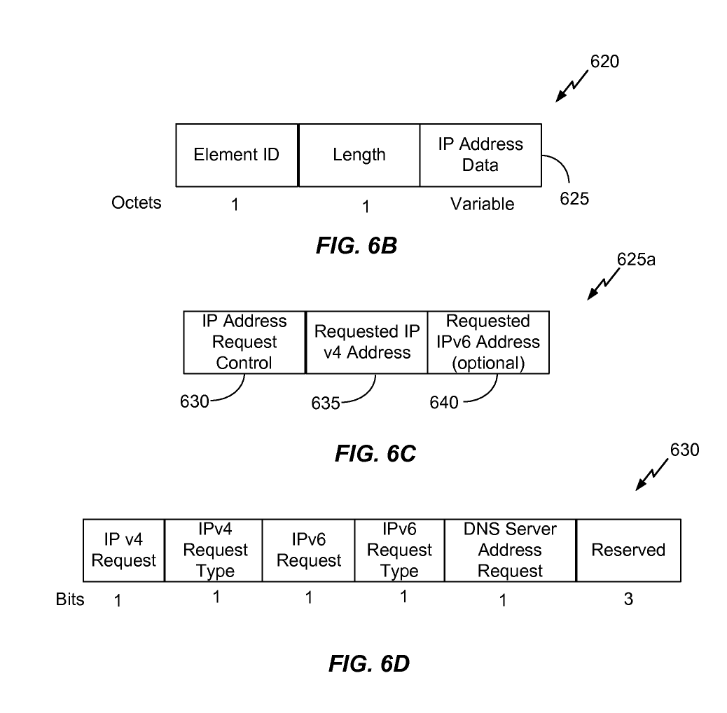

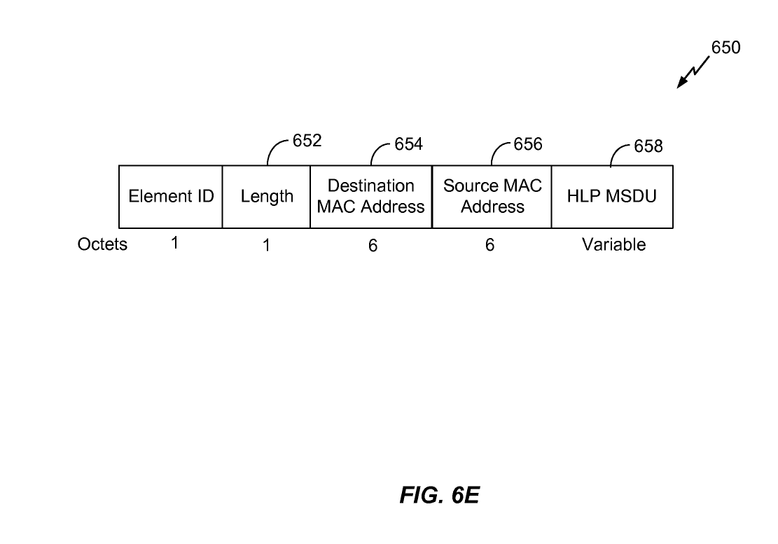

FIG. 6A shows an example message body for an authentication message. In some aspects, the authentication messages 1005 and/or 1010 may include the message body 600 of FIG. 6A. In some aspects, a Diffie-Hellman public value, such as P^{nb1} and/or P^{na1}, of authentication messages 1005 and 1010 of FIG. 3 respectively, may be stored in the scalar field 605, the element field 610, or a combination of the scalar field 605 and the element field 610. In some aspects, the FILS Nonce field 615 may store a nonce value, such as nonce value nb2 or na2 of FIG. 3.

In some aspects, the authentication message body 600 may include an IP address request information element (not shown). An example format of the IP address request information element 620 is shown in FIG. 6B. The IP address request information element 620 includes an IP Address data field 625. An example format of the IP address data field 625 for an association request is shown in FIG. 6C as 625a. The IP address data field 625a includes an IP address request control field 630, an example of which is shown in FIG. 6D. The IP address data field 625 also includes a requested IP address. A requested Internet protocol (IP) v4 address is carried in field 635 while a requested Internet protocol (IP) v6 address is carried in field 640. In some aspects, a device transmitting an authentication message may request use of a particular IP address for communication with a device receiving the authentication message using the IP address request information element 620. For example, in some aspects, the device 130a may request use of a particular IP address when communicating with device 130b by including the IP address request information element 620 in authentication request 1005. Similarly, the device 130b may request use of a particular IP address for communication with device 130a by including the IP address request information element 620 in authentication reply 1010.

In some other aspects, other methods may be used to request and/or assign IP addresses to devices transmitting or receiving authentication messages. For example, in some aspects, dynamic host configuration protocol (DHCP) may be utilized to request and/or assign IP addresses to a device. In these aspects, the authentication message body 600 may include a FILS HLP Container element.

FIG. 6E shows a fast initial link setup (FILS) high level protocol (HLP) container element. In some aspects, the HLP element 650 encapsulates frames transported during association. One or more FILS HLP container elements may be included in an association request or association response as discussed below, if dot11FILSActivated is true.

The HLP element 650 includes a length field 652, destination media access control (MAC) address field 658, source media access control (MAC) address field 656, and a MSDU field 654. If the length field 652 is less than 243 octets, the value of the length field is 12 plus the length of HLP MSDU field 658. If the length of the HLP MSDU field 658 is larger than 243 octets, the value of the Length field is 255.

The value of the destination MAC address field 654 is the destination MAC address of the HLP frame stored in the HLP MSDU field 658. The value of the source MAC address field 656 is the source MAC address of the HLP frame, which may be the same source address as the STA generating the HLP frame. The HLP MSDU field 658 contains the MSDU of the HLP frame.

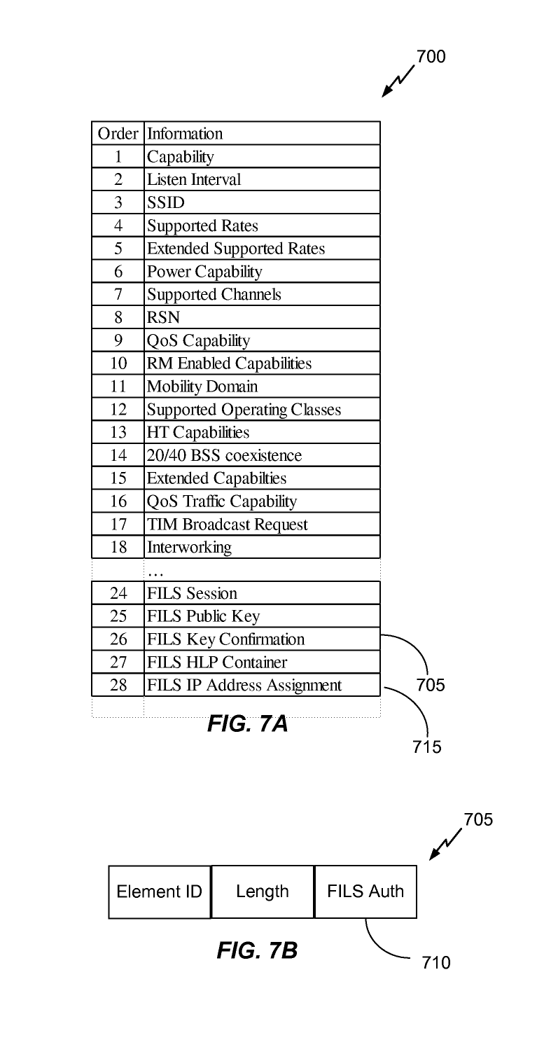

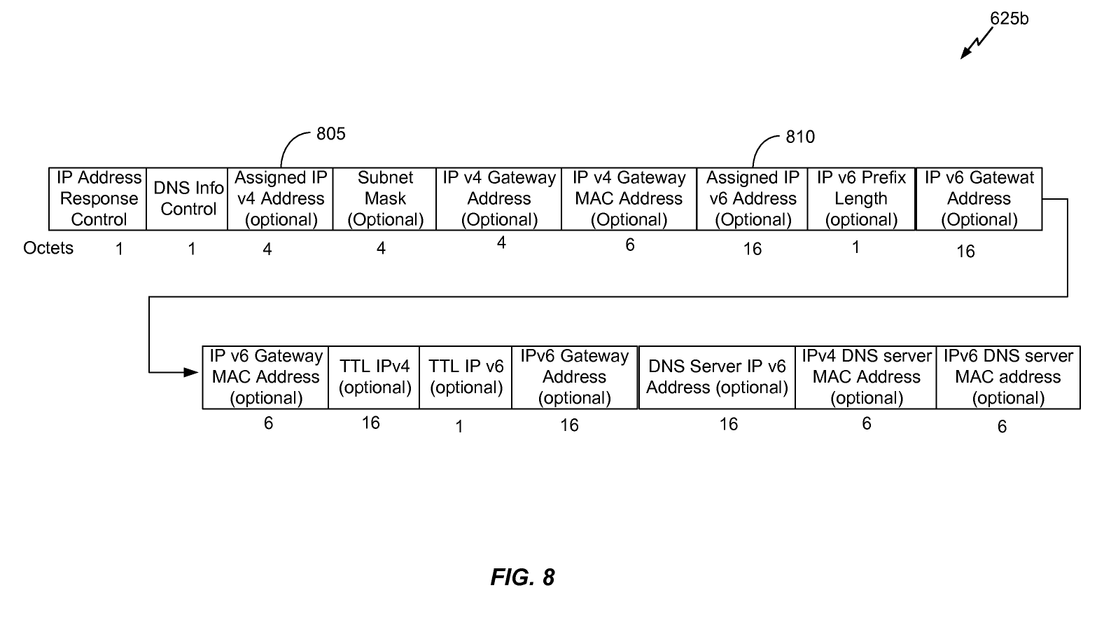

FIG. 7A shows an example message body of an association request message. In some aspects, the message body of the association request message 1015 of FIG. 3 may conform with the format shown in FIG. 7A. In various aspects, some or all of the fields shown in message body 900 may be present in an association request message.

In some aspects, the FILS Key Confirmation field 705 of the message body 700 may store a message integrity code, such as the message integrity code of association request 1015 of FIG. 3. In some other aspects, the association request 1015 may be protected using counter with cipher block chaining message authentication code (CBC-MAC) (CCM). In these aspects, the message integrity code may be carried in the encrypted payload of the protected association request. In some aspects, the message integrity code may be used as the message authentication code in the CBC-MAC protection. In some aspects, Galois Message Authentication Codes (GMAC) may be utilized. In these aspects, Galois/Counter Mode (GCM) may be used instead of CCM as discussed above.

In some aspects, an association request message body may include additional fields that are not information elements. In some aspects, the association request message body may include a confirm field (not shown). In some aspects, a message integrity code may be carried in the confirm field.

In some aspects, the association request message body may include information elements. For example, the FILS Key Confirmation element 705 may be included in the association request in some aspects. In some aspects, the FILS Key Confirmation element 705 may carry the message integrity code shown in FIG. 3, message 1015.

FIG. 7B shows one example format of a FILS Key Confirmation element 705. In some aspects, the message integrity code may be carried in the FILS Authentication field 710 of the FILS Key Confirmation element 705.

In some aspects, the association request message body may include an IP address assignment information element 715. In some aspects, the IP address assignment element 715 may be of the same format as IP address request information element 620 shown in FIG. 6B. However, in the IP address assignment information element 715, the IP address data field 625 may be of the format 625b shown in FIG. 8.

FIG. 8 shows an example IP address assignment information element 625b. The IP address data field 625b for a response includes an assigned IP v4 address field 805 and an assigned IP v6 address field 810. In some aspects, an IP address assigned to a device receiving the IP address assignment information element may be carried by either the field 805 or the field 810.

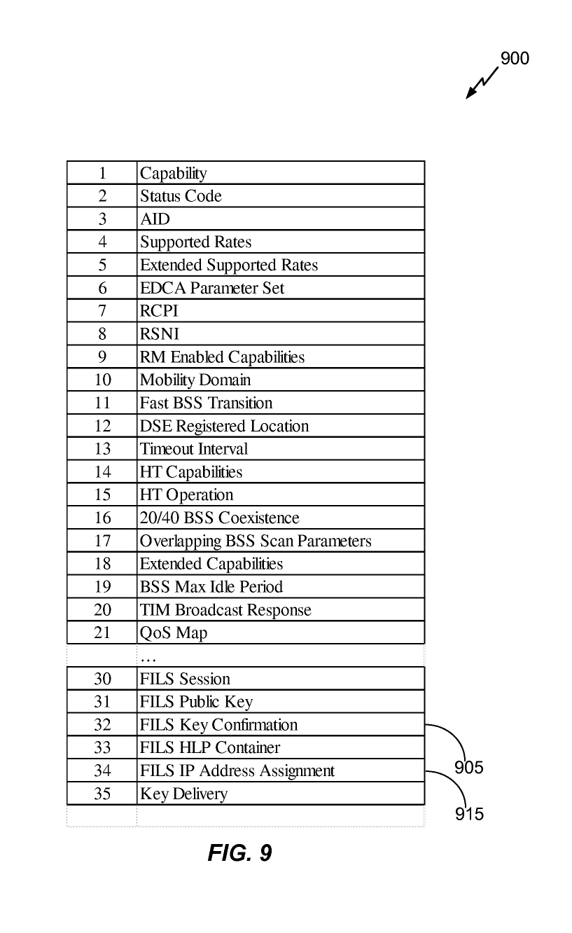

FIG. 9 shows an example message body of an association response message. In some aspects, the message body of the association response message 1020 of FIG. 3 may conform with the format of message body 900 shown in FIG. 9. In various aspects, only a portion or all of the fields shown in message body 900 may be present in an association response message.

In some aspects, the FILS Key confirmation element 905 may carry a message integrity code, such as the message integrity code discussed with respect to message 1020 in FIG. 3. In some aspects, the FILS Key confirmation element 905 may conform with the key confirmation element format 705 shown in FIG. 7B. In some other aspects, the message integrity code discussed with respect to message 1020 may be carried by another field of the association response, such as a confirm field.

In some aspects, the association response message body 900 includes an IP address assignment information element 915. As discussed above with respect to IP address assignment information element 715 of the association request message body 700, the IP address assignment information element may carry an IP address assigned for use by a device receiving the association response including the association response message body 900. In some aspects, the IP address assignment information element 915 substantially confirms with the IP address assignment information element 715, discussed with respect to FIG. 8.

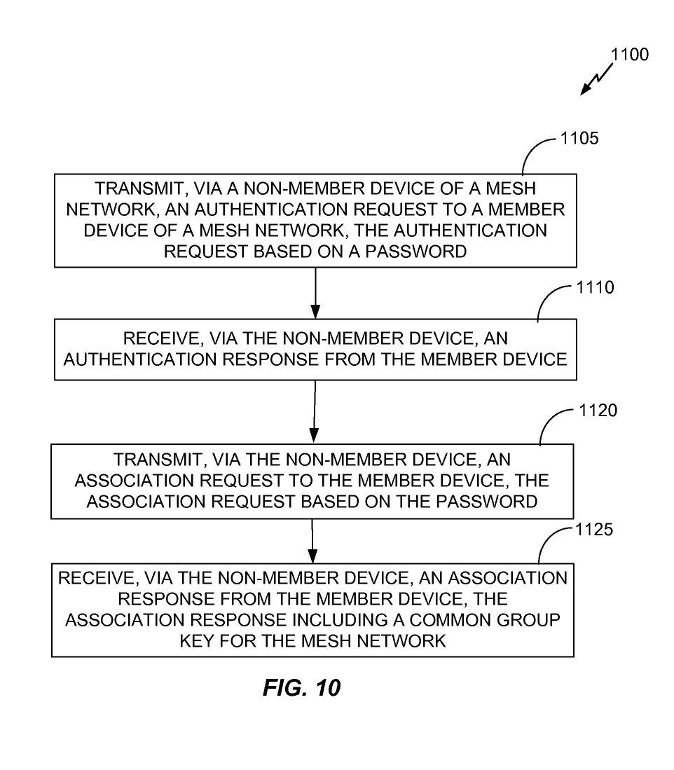

FIG. 10 shows one example of a method for efficient mesh peering. Method 1100 may be performed by the device 202 in some aspects. The method 1100 may also be performed by one or more of the devices 130a-c shown in FIG. 3. Relative to the specific discussion of FIG. 3 above, the method 1100 may be performed by the device 130b, which is the non-member device (but may be performed by other devices 130a and/or 130c as well).

In some known mesh peering processes, up to eight different messages may be exchanged to establish a secure mesh communication channel between two mesh peers. The disclosed mesh peering process provides a new member device with a common group key for the mesh network. The common group key may be used by each member device of a mesh to encrypt and decrypt group addressed messages exchanged between any member devices of the mesh.

The proposed method 1100 also integrates a mesh authentication process with an association process, resulting in efficiencies that further reduce the complexity of mesh association. The disclosed secure mesh peering process may be performed with the exchange of just four messages between the member and non-member devices. This may result in reduced latency and computational overhead in mesh association.

In block 1105, an authentication request is transmitted by a non-mesh member device to a member device of the mesh network. In some aspects, the non-member device, which is transmitting the authentication request, may be requesting to join the mesh network with the authentication request. In some aspects, the authentication request may share one or more characteristics of the authentication request 1005 discussed above with respect to FIG. 3.

Both the member and non-member devices may share a common password. For example, the common password may be independently received via an input interface on each device. Each of the member and non-member devices may create a password element (P) using the password. The non-member device may utilize the password element to generate a Diffie-Hellman (DH) public value based on a first nonce value. In some aspects, the authentication request transmitted in block 1105 includes the public value. In this way, the authentication request is based on the password, because it includes the Diffie-Hellman public value that was generated based on a nonce that was generated based on a password element, which was based on the password. In some aspects, the authentication request also includes a second nonce value generated by the non-member device.

In some aspects, the public value generated based on the first nonce value may be encoded in an element field or a scalar field of the authentication request. In some aspects, the public value may be encoded in both the element field and the scalar field. In some aspects, the second nonce value may be encoded in a FILS Nonce Field, such as FILS Nonce field 615 shown in FIG. 6A.

In some aspects, the non-member device determines a proposed IP address for its use during mesh communications with the member device. The authentication request may be generated by the non-member device to include the proposed IP address. For example, in some aspects, the proposed IP address may be carried in the IP address request information element 620, discussed with respect to FIGS. 6B-6D. In some other aspects, a proposed IP address may not be included in the authentication request. In some of these aspects, DHCP may be used for address assignment.

In block 1110, the non-member device receives an authentication response from the member device. In some aspects, the non-member device decodes a public value from the authentication response. The public value may have been independently generated by the member device. For example, in some aspects, the decoded public value may have been generated by the member device based on a third nonce. The non-member device may also decode a fourth nonce value from the authentication response. The fourth nonce may have also been independently generated by the member device. In some aspects, the decoded public value may be decoded from one or more of an element field 610 and/or a scalar field 605 of the authentication response. In some aspects, the fourth nonce value may be decoded from a FILS Nonce field 615. Note that the use of the term “decode” or “decoding” in this disclosure does not necessarily imply decryption or translation of a particular value. For example, in some aspects, decoding a value from a message may comprise extracting the value from message data and processing it in some manner. For example, in some aspects, a decoded value may be used as an input parameter to another process.

In some aspects, at least a portion of a proposed IP address for the member device may be decoded from the authentication response. For example, the authentication response may include one or more of the features discussed above with respect to message 1010 of FIG. 3. In some aspects, the proposed IP address for the member device may be decoded from an IP address request information element, such as the information element 620 shown in FIG. 6B. In some other aspects, a proposed IP address may not be included in the authentication response. As discussed above, some aspects may use other means to negotiate and/or assign IP addresses to members of a mesh network. For example, in some aspects, DHCP may be used for address assignment.

In some aspects of process 1100, a pair wise master key (PMK) is generated based on the authentication response. In some aspects, the PMK may be generated in substantial accordance with the PMK in SAE authentication. For example, the PMK may be generated based on one or more of the first nonce, second nonce, public value based on the third nonce, and/or the fourth nonce.

In some aspects, a pairwise transient key (PTK) is generated by the non-member device based on at least the pairwise master key, the second nonce value and the fourth nonce value. In some aspects, the PTK may be generated based on a mesh peering instance identifier. In some aspects, the mesh peering instance identifier is based on a local link identifier, a media access control (MAC) address of the non-member device, and a media access control (MAC) address of the member device. The local link identifier may be generated by the member device, and may be unique among all existing link identifiers used by the member device. In some aspects, if “dot11MeshSecurityActivated” is true, the mesh peering instance also contains a PMKID identifying a shared PMK Security Association (PMKSA), a localNonce chosen by the member device and a peerNonce chosen by the non-member device.

A message integrity code (MIC)) is then generated by the non-member device based on the PTK.

In block 1120, an association request is transmitted to the member device. In some aspects, the association request message includes the generated MIC. As discussed above, the message integrity code may be carried in some aspects by a FILS Key confirmation information element, such as information element 705 discussed with respect to FIG. 7B. In some other aspects, for example, those that utilize an authenticated encryption with associated data (AEAD) algorithm or method, such as CCM, or GCM to protect the association request, the message integrity code may be carried in the encrypted payload of the association request message. In some other aspects, a confirm field of the association request may be used to carry the message integrity code. In some aspects, the association request may share one or more characteristics of the association request 1015 discussed above with respect to FIG. 3.

In some aspects, the non-member device also assigns an association identifier to the member device. In some of these aspects, the association identifier is also included in the association request. The association identifier may be used by the non-member device to identify the member device as an intended destination when the non-member device transmits a mesh message. The association request may also include one or more indications of PHY/MAC capabilities of the non-member device.

In some aspects, the association request also includes an IP address assigned to the member device by the non-member device. The IP address should be used as a source address by the member device for mesh communications between the member and non-member devices. In some aspects, the assigned IP address is carried in an IP address assignment information element, as described above with respect to FIG. 7A and FIG. 8. In some other aspects, an assigned IP address is not included in an IP address assignment information element of the association request. Instead, in some aspects, DHCP may be used to assign IP addresses. In some of these aspects, the association request may carry a DHCP protocol message via an information element, such as a FILS HLP container element 650 as shown in FIG. 6E.

In block 1125, an association response is received from the member device. In some aspects, a second message integrity code (MIC) may be decoded from the association response. The decoded MIC may be used to determine whether the non-member device and the member device share the same password. In some aspects, the message integrity code may be decoded from a FILS Key Confirmation information element. In some aspects, the MIC may be decoded from another field of the association response, for example, a confirm field such as defined in section 8.4.1.4.41 of the 802.11 2012 specification. In some other aspects, for example, those that protect the association response via an authenticated encryption with associated data, such as CCM or GCM, the MIC may be decoded from the encrypted payload of the association response.

The MIC received from the member device in the association response may be compared to the generated MIC. If the decoded and generated MICs are equivalent, the non-member device may determine that the member and non-member devices can be associated.

In some aspects, an association identifier for the non-member device may be decoded from the association response. The decoded association identifier may be used when communicating with the member device on the mesh network. For example, communications between the non-member device and the member device may use the decoded association identifier to indicate that a mesh message is transmitted by the non-member device, or destined for the non-member device.

In some aspects, MAC and/or PHY capabilities of the member device may be decoded from the association response by the non-member device. The capabilities may be used by the non-member device to determine how to communicate with the member device.

A common group key for the mesh network may be decoded from the association response by the non-member device. The group key may be common for devices within the mesh network. The group key may be used by the non-member device to encrypt group addressed messages for transmission to devices on the mesh network. The group key may also be used by the non-member device to decode group addressed messages received from any other device that is a member of the mesh network.

In some aspects, the association response may be equivalent to the association response message 1020 of FIG. 3. For example, an IP address for the non-member device to use as a source IP address when exchanging messages between the member device and the non-member device may be decoded from the association response. In some aspects, the IP address assigned to the non-member device may be decoded from an IP address assignment information element, such as is discussed above with respect to FIG. 7A and field 715. Alternatively, in some aspects, the association response may include a FILS HLP Container element, which, in some aspects, may carry DHCP protocol information that functions to assign IP addresses. An example of the HLP Container element is shown in FIG. 6E.

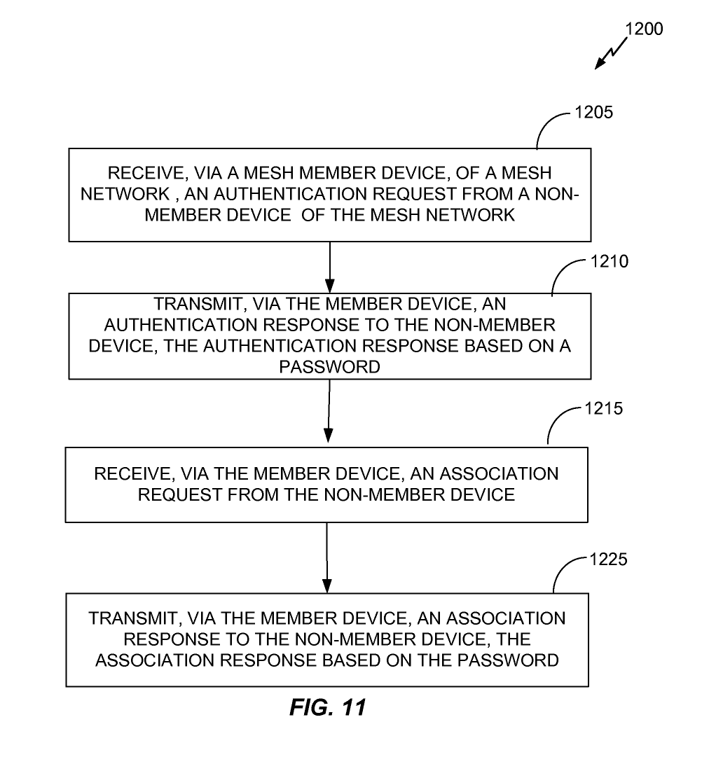

In some aspects, the method 1100 may be implemented by a device including at least an authentication circuit and an association circuit. The authentication circuit may be configured to perform one or more of the functions discussed above with respect to the block 1105-1110 illustrated in FIG. 10. In some aspects, the authentication circuit may correspond to the processor 204 and/or the transmitter 210 and/or the receiver 212. The association circuit may be configured to perform one or more of the functions discussed above with respect to blocks 1120-1125 illustrated in FIG. 11. In some aspects, the association circuit may correspond to the processor 204.

FIG. 11 shows one example of a method for mesh peering. Method 1200 may be performed by the device 202 in some aspects. The method 1200 may also be performed by one or more of the devices 130a-c shown in FIG. 3. Specifically with regard to the discussion of FIG. 3, the process 1200 may be performed by the member device 130a.

The method 1200 may be utilized to provide for a more efficient mesh peering process. For example, in some known mesh peering processes, up to eight different messages may be exchanged to establish a secure mesh communication channel between two mesh peers. By integrating an authentication process with an association process, a secure mesh peer connection may be performed with the exchange of just four messages between two mesh peer devices. This may result in reduced latency and computational overhead for mesh peer devices.

Process 1200 is a method performed by a member of a mesh network. The member device authenticates and associates with a non-member device of the mesh network. After the authentication and association is completed, the non-member device becomes a member device, and is able to encrypt and decode group addressed messages on the mesh network using a common group key.

In block 1205, a member device of a mesh network receives an authentication request from a non-member device. The member device is participating in a mesh network. In some aspects, the non-member device, which is transmitting the authentication request, may be requesting to join the mesh network with the authentication request. In some aspects, the authentication request may share one or more characteristics with the authentication request 1005 discussed above with respect to FIG. 3.

In some aspects, the authentication request received in block 1205 includes a public value that was generated based on a first nonce value, the public value being generated by the non-member device. In some aspects, the authentication request also includes a second nonce value, which may have also been generated by the non-member device. The member device may decode the public value based on the first nonce value and/or the second nonce value from the authentication request. In some aspects, the public value may be decoded from an element field or a scalar field of the authentication request. In some aspects, the public value may be decoded from both the element field and the scalar field of the authentication request. In some aspects, the second nonce value may be decoded from a FILS Nonce Field, such as FILS Nonce field 615 shown in FIG. 6A.

In some aspects, the member device may decode a proposed IP address for use by the non-member device in mesh communications with the member device from the authentication request. For example, the proposed IP address may be decoded from an IP address request information element, as shown above with respect to FIGS. 6B-D and field 620. Other aspects of the authentication request may not include a proposed IP address.

Both the non-member and member devices may share a common password. For example, the common password may be independently received via an input interface on each device. Each of the non-member and member devices may create a password element (P) using the password. In some aspects, the password element may be generated in a manner similar to that used in SAE authentication.

The member device may generate a third and fourth nonce value. Using the password element, the non-member device may generate a public value based on the third nonce value. For example, the public value may be a Diffie-Hellman (DH) public value based on the third nonce value.

In block 1210, the member device transmits an authentication response to the non-member device. The authentication response may include the public value based on the third nonce value and/or the fourth nonce value. In some aspects, the member device generates the authentication response to include a proposed IP address that the member device may use as a source IP address when communicating with the non-member device during mesh communications. In some aspects, the authentication response may share one or more characteristics of the authentication reply 1010 discussed above with respect to FIG. 10. For example, the proposed IP address may be carried in the authentication response via a IP Address request information element, as shown with respect to FIGS. 6B-6D and field 620. Other aspects of the authentication response may not carry a proposed IP address.

In some aspects of process 1200, a pair wise master key (PMK) is generated by the member device based on the authentication request received in block 1205, and the third and fourth nonce values. The PMK may be generated based on the public value which was generated based on the first nonce, second nonce, third nonce, and/or the fourth nonce. In some aspects, the PMK is generated in substantial accordance with the method used in SAE authentication.

In some aspects, a pairwise transient key (PTK) is generated by the member device based on at least the pairwise master key, the second nonce value and the fourth nonce value. In some aspects, a PTK is generated in substantial accordance with the method described in 802.11ai authentication. In some aspects, the PTK is generated based on a mesh peering instance identifier. In some aspects, the mesh peering instance identifier is based on a local link identifier, a media access control (MAC) address of the non-member device, and a media access control (MAC) address of the member device. The local link identifier may be generated by the member device, and may be unique among all existing link identifiers used by the member device. In some aspects, if “dot11MeshSecurityActivated” is true, the mesh peering instance also contains a PMKID identifying a shared PMK Security Association (PMKSA), a local Nonce chosen by the member device and a peer Nonce chosen by the non-member device.

A message integrity code (MIC) is then generated by the member device based on the PTK.

In block 1215, an association request is received by the member device. A message integrity code (MIC) is decoded from the association request message. In some aspects, the MIC may be decoded from a FILS Key confirmation information element, such as information element 705 discussed above with respect to FIG. 7B. In some aspects, the MIC is decoded from the payload of the association request message. For example, in aspects that protect the association request message payload using an authenticated encryption with associated data (AEAD) algorithm or method, such as CCM or GCM, the MIC may be decoded from the decrypted payload.

The decoded MIC may be used to determine whether the non-member device and the member device share the same password. The decoded MIC may also be used to verify that the same keys (for example, the PMK and/or PTK) are derived by both the non-member device and the member device. For example, the member device may generate a second MIC, based on the PTK as discussed above. By comparing the second MIC to the decoded MIC, the member device can determine if the member device and non-member device share the same password (if the two MICs are equivalent, the two passwords are equivalent).

In some aspects, an association identifier is decoded from the association request. The association identifier is assigned to the member device by the non-member device for use in mesh message exchanges with the non-member device. For example, the member device may determine whether a mesh message transmitted by the non-member device (after it becomes a member of the mesh) is intended for the member device based on whether the association identifier is included in the mesh message.

In some aspects, an IP address assigned to the member device for communication with the non-member device is decoded from the association request. In some aspects, the association request includes an IP address assignment information element, as described above with respect to information element 715 of FIG. 7A. In these aspects, the member device may decode the information element 715 to determine the assigned IP address. In some other aspects, IP addresses may be assigned using alternative means. For example, in some aspects, DHCP may be used to assign IP addresses to the member and/or non-member devices. The DHCP messages may be carried in an association request in some aspects via a FILS HLP Container element. An example FILS HLP Container element is shown in FIG. 6E.

In block 1225, an association response is transmitted to the non-member device. In some aspects, the member device also assigns a second association identifier to the non-member device. In some of these aspects, the second association identifier is also included in the association response. The second association identifier may be included in mesh messages transmitted by the member device when the message is destined for the non-member device.

The generated MIC discussed above may be included in the association response by the member device. For example, the generated MIC may be encoded in a FILS Key Confirmation Information element 905 in some aspects. In some aspects, the association response may be protected via CCM. In these aspects, the MIC may be communicated in the encrypted payload of the association response.

A common group key for the mesh network may be included in the association response by the member device. The group key may be common for devices within the mesh network. The common group key may be used by the non-member device to encrypt group addressed messages for transmission to the mesh network. The common group key may also be used by the non-member device to decode group addressed messages received from the mesh network.

In some aspects, an IP address for the non-member device to use as a source IP address when exchanging messages between the member device and the non-member device may be included in the association response by the member device. In some aspects, the association response is generated to include a FILS IP address assignment information element 915, as discussed above with respect to FIG. 9. The information element 915 may encode an IP address assigned to the non-member device. In some aspects, an assigned IP address is not communicated via the FILS IP address assignment information element 915. In some of these aspects, the IP address may be assigned via DHCP. In some aspects, the DHCP protocol messages may be carried in the association response via a FILS HLP Container element. An example of the FILS HLP Container element is shown in FIG. 6E.

In some aspects, the member device generates the association response message to include indications of one or more PHY/MAC capabilities of the member device.

The method 1200 may be implemented in some aspects by an authentication circuit and an association circuit. The authentication circuit may be configured to perform one or more of the functions discussed above with respect to the block 1205-1210 illustrated in FIG. 11. In some aspects, the authentication circuit may correspond to the processor 204 and/or the transmitter 210 and/or the receiver 212. The association circuit may be configured to perform one or more of the functions discussed above with respect to blocks 1215-1225 illustrated in FIG. 11. In some aspects, the association circuit may correspond to the processor 204.

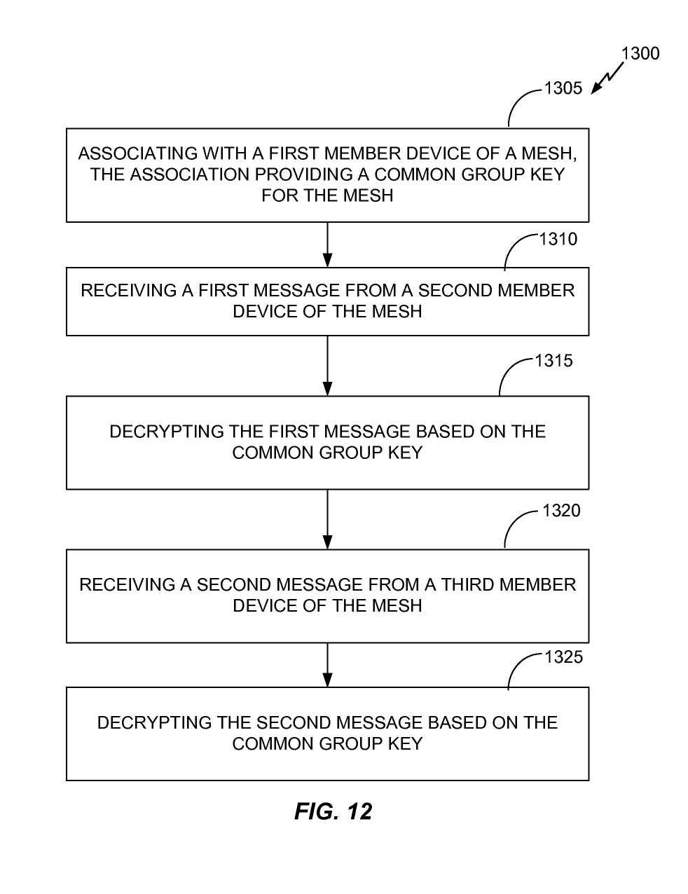

FIG. 12 shows one example of a method for mesh peering. Method 1300 may be performed by the device 202 in some aspects. The method 1300 may also be performed by one or more of the devices 130a-c shown in FIG. 3. Specifically with regard to the discussion of FIG. 3, the method 1300 may be performed by the device 130b (the non-member device). However, other devices 130a and/or 130c may also perform process 1300.

The method 1300 may be utilized to provide for a more efficient mesh peering process. For example, in some known mesh peering processes, in order for a new device to join the mesh, the new device must associate with each member device of the mesh, before messages transmitted by a particular member device may be decoded by the new member device. The disclosed methods and systems provide a common group key that may be used to decode a message transmitted by any member device of the mesh. This allows a new member device receiving the messages to associate with as few as one other member device before messages from other mesh devices may be decrypted or encrypted and transmitted to the mesh. For example, after obtaining the common group key from a member device of the mesh, a new device may transmit and receive routing or path messages with other member devices of the mesh. Upon determining that a particular path maintained by a particular member device is of use, the new device may then determine to associate with the particular device. The new device may determine not to associate with at least some other member devices of the mesh. For example, other member devices that may not provide any service of interest or value to the new device (non-member device) and thus may not be associated with by the new member device.

In block 1305, an association with a first member device of a mesh is performed by a non-member device. The association with the first member device provides a common group key for the mesh to the non-member device. In some aspects, the common group key may be used to encrypt and/or decrypt one or more group addressed messages transmitted or received on the mesh. In some aspects, the association of block 1305 may be performed as described by process 1100 and FIG. 10. After the association is complete, the non-member device may be a member of the mesh network. Therefore, the same device may be referred to in the discussion below as a new member device.

In block 1310, a first message is received from a second member device of the mesh. In some aspects, the first message may be a path response message (PREP), which includes information relating to a route to a service provided by the mesh network.

In some aspects, reception of the first message is preceded by transmission of a path request message (PREQ) by the non-member device. The transmitted path request message may include a sequence number that enables the new member device to match any received path response messages to this path request message.

The transmitted path request message may be encrypted and/or decrypted based on the common group key received from the association of block 1305. In these aspects, the common group key received during the association may be common for all member devices of the mesh. This may enable encrypting and decryption of group addressed messages to be exchanged between mesh member devices based on the common group key.

In block 1315, the first message is decrypted based on the common group key provided by the association process of block 1305. Note that the mesh may utilize the common group key to encrypt and/or decrypt group addressed messages transmitted by multiple member devices of the mesh. Therefore, the new member device may decrypt messages transmitted by mesh member devices that are not associated with the new member device.

In block 1320, a second message is received from a third member device of the mesh. The second message may also be a routing message or path response message in some aspects. In some aspects, the second path response message includes the same sequence number as a path request message transmitted by the new member device discussed above. (i.e. the first and second path response messages are in response to the same path request message, but perhaps transmitted by different member devices).

In some aspects, the second message is unrelated to the first message. For example, the second message may be a path response message, similar to the first message in some aspects, but transmitted in response to a different path request message than the path request message discussed previously. Therefore, in some aspects, reception of the second message is preceded by transmission of a second path request message. The transmitted second path request message may be encrypted based on the common group key received from the association of block 1305.

In block 1325, the second message is decrypted based on the common group key. Because the mesh utilizes the common group key to encrypt and/or decrypt group addressed messages transmitted by both at least the second and third member devices of the mesh, the new member device is able to successfully decrypt messages transmitted by the second and third member devices, despite the new member device not being associated with either the second or third member devices.

In some aspects, after successfully decrypting at least one message from one or more of the second and/or third member devices, the new member device may determine that it should associate with the second and/or third member devices. For example, an association with at least one of these devices may be performed in order to access one or more services provided by the one or more devices. This association may be performed in some aspects in substantial accordance with process 1100 of FIG. 10. Once the association is completed successfully, the new member device may exchange one or more service messages with the newly associated device. In some other aspects, block 1320 and 1325 may not be performed by process 1300.

Some aspects of process 1300 may encrypt unicast packets using the common group key—in such implementations, mesh traffic may also be encrypted using the group key.

Method 1300 may be performed in some aspects by an association circuit and a receiving circuit, and a decrypting circuit. The association circuit may be configured to perform one or more of the functions discussed above with respect to the block 1305 illustrated in FIG. 12. In some aspects, the association circuit may correspond to the processor 204 and/or the transmitter 210 and/or the receiver 212. The receiving circuit may be configured to perform one or more of the functions discussed above with respect to blocks 1310 and/or 1320 illustrated in FIG. 12. In some aspects, the receiving circuit may correspond to the receiver 212. The decrypting circuit may be configured to perform one or more of the functions discussed above with respect to blocks 1315 and/or 1325 illustrated in FIG. 12. In some aspects, the decrypting circuit may correspond to the processor 204.

Those of skill would further appreciate that the various illustrative logical blocks, configurations, modules, circuits, and algorithm steps described in connection with the embodiments disclosed herein may be implemented as electronic hardware, computer software, or combinations of both. Various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of storage medium known in the art. An exemplary non-transitory (e.g., tangible) storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A method of peer association of a non-member device of a mesh network with a member device of the mesh network, comprising:
transmitting an authentication request from the non-member device to the member device of the mesh network, wherein the authentication request is based on a password;
receiving an authentication response from the member device by the non-member device;
transmitting an association request from the non-member device to the member device based on the authentication response, wherein the association request is further based on the password; and
receiving an association response from the member device by the non-member device.

2. The method of claim 1, further comprising:
generating a pairwise master key (PMK) based on the authentication response;
decoding a nonce from the authentication response;
generating a pairwise transient key (PTK) based on the pairwise master key (PMK) and the nonce; and
generating the association request based on the pairwise transient key.

3. The method of claim 2, further comprising generating the pairwise transient key based on a mesh peering instance identifier.

4. The method of claim 2, further comprising:
generating a message integrity code (MIC) based on the pairwise transient key; and
generating the association request to indicate the message integrity code.

5. The method of claim 4, further comprising:
assigning an association identifier to the member device; and
further generating the association request to indicate the association identifier of the member device.

6. The method of claim 4, further comprising:
decoding an association identifier from the association response;
generating a mesh message to comprise the association identifier; and
transmitting the mesh message to the member device.

7. The method of claim 1, further comprising:
generating a first message integrity code (MIC) based on the password;
decoding the association response to determine a second message integrity code (MIC);
comparing the first message integrity code (MIC) to the second message integrity code (MIC); and
determining whether the non-member device is associated with the member device based on the comparison.

8. The method of claim 1, further comprising:
decoding a group key from the association response;
receiving a mesh message from a second non-member device; and
decoding the mesh message based on the group key.

9. The method of claim 1, further comprising:
decoding a group key from the association response;
generating a path request message to comprise a sequence number;
encrypting the path request message based on the group key; and
transmitting the encrypted path request message on the mesh network.

10. The method of claim 9, further comprising:
receiving a path response message from a second member device of the mesh;
decrypting the path response message based on the group key;
decoding the sequence number from the decrypted path response message; and
associating with the second member device based on the decrypted path response.

11. The method of claim 1, further comprising decoding an Internet Protocol address for use in communication on the mesh from the association response.

12. The method of claim 1, further comprising generating the authentication request to indicate at least a portion of a proposed Internet Protocol address for use by the non-member device in communication on the mesh network.

13. A non member apparatus of a mesh network for associating with a member device of the mesh network, comprising:
a processor, configured to generate an authentication request based on a password;
a transmitter, configured to transmit the authentication request from the non-member apparatus to a member device of the mesh network;
a receiver, configured to receive an authentication response from the member device,
wherein the processor is further configured to generate an association request based on the authentication response and the password,
wherein the transmitter is further configured to transmit the association request from the non-member apparatus to the member device, and
wherein the receiver is further configured to receive an association response from the member device.

14. The apparatus of claim 13, wherein the processor is further configured to:
generate a pairwise master key (PMK) based on the authentication response;
decode a nonce from the authentication response;
generate a pairwise transient key (PTK) based on the pairwise master key (PMK) and the nonce; and
generate the association request based on the pairwise transient key.

15. The apparatus of claim 14, wherein the processor is further configured to generate the pairwise transient key based on a mesh peering instance identifier.

16. The apparatus of claim 14, wherein the processor is further configured to:
generate a message integrity code (MIC) based on the pairwise transient key, and
generate the association request to indicate the message integrity code.

17. The apparatus of claim 15, wherein the processor is further configured to:
assign an association identifier to the member device, and
further generate the association request to indicate the association identifier of the member device.

18. The apparatus of claim 15, wherein the processor is further configured to:
decode the association response to determine an association identifier,
generate a mesh-message to comprise the association identifier, and wherein the transmitter is further configured to transmit the mesh message to the member device.

19. The apparatus of claim 13, wherein the processor is further configured to:
generate a first message integrity code (MIC) based on the password;
decode the association response to determine a second message identity code (MIC);
compare the first message integrity code to the second message integrity code; and
determine whether the non-member device is associated with the member device based on the comparison.

20. The apparatus of claim 13,
wherein the processor is further configured to decode a group key from the association response,
wherein the receiver is further configured to receive a mesh message from a second non-member device, and
wherein the processor is further configured to decode the mesh message based on the group key.

21. The apparatus of claim 13, wherein the processor is further configured to:
decode a group key from the association response,
generate a path request message to comprise a sequence number,
encrypt the path request message based on the group key, and wherein the transmitter is further configured to transmit the encrypted path request message on the mesh network.

22. The apparatus of claim 21,
wherein the transmitter is further configured to receive a path response message from a second member device of the mesh, and
wherein the processor is further configured to:
decode the path response message based on the group key,
decode the sequence number from the decoded path response message, and
associate with the second member device based on the decoded path response message.

23. The apparatus of claim 13, wherein the processor is further configured to decode an Internet Protocol address for use in communication on the mesh from the association response.

24. The apparatus of claim 13, wherein the processor is further configured to generate the authentication request to indicate at least a portion of a proposed Internet Protocol address for use by the non-member device in communication on the mesh network.

25. A computer readable storage medium comprising instructions that when executed cause a processor to perform a method of peer association of a non-member device in a mesh network with a member device of the mesh network, the method comprising:
transmitting an authentication request from the non-member device to a member device of the mesh network, wherein the authentication request is based on the password;
receiving, an authentication response from the member device by the non-member device;
transmitting an association request from the non-member device to the member device based on the authentication response, wherein the association request is further based on the password; and
receiving, an association response from the member device by the non-member device.

26. The computer readable storage medium of claim 25, the method further comprising:
generating a pairwise master key (PMK) based on the authentication response;
decoding a nonce from the authentication response;
generating a pairwise transient key (PTK) based on the pairwise master key (PMK), and the nonce; and
generating the association request based on the pairwise transient key.

27. The computer readable storage medium of claim 26, the method further comprising generating the pairwise transient key (PTK) based on a mesh peering instance identifier.

28. The computer readable storage medium of claim 26, the method further comprising:
generating a message integrity code (MIC) based on the pairwise transient key; and
generating the association request to indicate the message integrity code.

29. The computer readable storage medium of claim 28, the method further comprising:
assigning an association identifier to the member device; and
further generating the association request to indicate the association identifier of the member device.

30. The computer readable storage medium of claim 28, the method further comprising:
decoding an association identifier from the association response;
generating a mesh message to comprise the association identifier; and
transmitting the mesh message to the member device.

31. The computer readable storage medium of claim 25, the method further comprising:
generating a first message integrity code (MIC) based on the password;
decoding the association response to determine a second message integrity code (MIC);
comparing the first message integrity code (MIC) to the second message integrity code (MIC); and
determining whether the non-member device is associated with the member device based on the comparison.

32. The computer readable storage medium of claim 25, the method further comprising:
decoding a group key from the association response;
receiving a mesh message from a second non-member device; and
decoding the mesh message based on the group key.

33. The computer readable storage medium of claim 25, the method further comprising:
decoding a group key from the association response;
generating a path request message to comprise a sequence number;
encrypting the path request message based on the group key; and
transmitting the encrypted path request message on the mesh network.

34. The computer readable storage medium of claim 33, the method further comprising:
receiving a path response message from a second member device of the mesh;
decrypting the path response message based on the group key;
decoding the sequence number from the decrypted path response message; and
associating with the second member device based on the decrypted path response.

35. The computer readable storage medium of claim 25, the method further comprising decoding an Internet Protocol address for use in communication on the mesh from the association response.

36. The computer readable storage medium of claim 25, the method further comprising generating the authentication request to indicate at least a portion of a proposed Internet Protocol address for use by the non-member device in communication on the mesh network.

37. An apparatus for associating with a peer on a mesh network, comprising:
means for generating an authentication request based on the password;
means for transmitting the authentication request to a member device of the mesh network;
means for receiving an authentication response from the member device;
means for generating an association request based on the authentication response and the password;
means for transmitting the association request to the member device; and
means for receiving an association response from the member device.

38. The apparatus of claim 37, further comprising:
means for generating a pairwise master key (PMK) based on the authentication response;
means for decoding a nonce from the authentication response;
means for generating a pairwise transient key (PTK) based on the pairwise master key (PMK), and the nonce; and
means for generating the association request based on the pairwise transient key.

39. The apparatus of claim 38, further comprising means for generating the pairwise transient key (PTK) based on a mesh peering instance identifier.

40. The apparatus of claim 38, further comprising:
means for generating a message integrity code (MIC) based on the pairwise transient key; and
means for generating the association request to indicate the message integrity code.

41. The apparatus of claim 40, further comprising:
means for assigning an association identifier to the member device; and
means for further generating the association request to indicate the association identifier of the member device.

42. The apparatus of claim 40, further comprising:
means for decoding the association response to determine an association identifier;
means for generating a mesh-message to comprise the association identifier; and
means for transmit the mesh message to the member device.

43. The apparatus of claim 37, further comprising:
means for generating a first message integrity code (MIC) based on the password;
means for decoding the association response to determine a second message identity code (MIC);
means for comparing the first message integrity code to the second message integrity code; and
means for determining whether the non-member device is associated with the member device based on the comparison.

44. The apparatus of claim 37, further comprising:
means for decoding a group key from the association response;
means for receiving a mesh message from a second non-member device; and
means for decoding the mesh message based on the group key.

45. The apparatus of claim 37, further comprising:
means for decoding a group key from the association response;
means for generating a path request message to comprise a sequence number;
means for encrypting the path request message based on the group key and;
means for transmitting the encrypted path request message on the mesh network.

46. The apparatus of claim 45, further comprising:
means for receiving a path response message from a second member device of the mesh;
means for decoding the path response message based on the group key;
means for decoding the sequence number from the decoded path response message; and
means for associating with the second member device based on the decoded path response message.

47. The apparatus of claim 37, further comprising means for decoding an Internet Protocol address for use in communication on the mesh from the association response.

48. The apparatus of claim 37, further comprising means for generating the authentication request to indicate at least a portion of a proposed Internet Protocol address for use by the non-member device in communication on the mesh network.

49. A method of associating a non-member device of a mesh network with a member device of the mesh network, comprising:
receiving by the member device of the mesh network, an authentication request;
transmitting an authentication response from the member device to the non-member device, wherein the authentication response is based on a password;
receiving, by the member device, an association request from the non-member device; and
transmitting an association response from the member device to the non-member device, wherein the association response is based on the password.

50. The method of claim 49, further comprising:
decoding a nonce from the authentication request;
generating a pairwise master key (PMK) based on the authentication request;
generating a pairwise transient key (PTK) based on the pairwise master key (PMK) and the nonce; and
generating the association response based on the pairwise transient key.

51. The method of claim 50, further comprising generating the pairwise transient key (PTK) based on a mesh peering instance identifier.

52. The method of claim 50, further comprising:
generating a message integrity code (MIC) based on the pairwise transient key; and
generating the association response to indicate the message integrity code.

53. The method of claim 52, further comprising:
assigning an association identifier to the non-member device; and
further generating the association response to indicate the association identifier of the non-member device.

54. The method of claim 52, further comprising:
decoding the association request to determine an association identifier;
generating a mesh message to comprise the association identifier; and
transmitting the mesh message to the non-member device.

55. The method of claim 49, further comprising:
generating a first message integrity code (MIC) based on the password;
decoding the association request to determine a second message integrity code (MIC);
comparing the first message integrity code (MIC) to the second message integrity code (MIC); and
determining whether the non-member device is associated with the member device based on the comparison.

56. The method of claim 49, further comprising:
generating the association response to include a group key for the mesh network;
receiving a message from the mesh network; and
decoding the message based on the group key.

57. The method of claim 49, further comprising decoding an Internet Protocol address for use in communication with the non-member device from the association request.

58. The method of claim 49, further comprising generating the authentication response to indicate at least a portion of a proposed Internet Protocol address for use by the member device in communication with the non-member device on the mesh network.

59. A member apparatus of a mesh network for associating with a non-member device of the mesh network, comprising:
a receiver configured to receive an authentication request from the non-member device;
a transmitter configured to transmit an authentication response from the member apparatus to the non-member device, wherein the authentication response is based on a password,
wherein the receiver is further configured to receive an association request from the non-member device, and
wherein the transmitter is further configured to transmit an association response from the non-member apparatus to the non-member device, wherein the association response is based on the password.

60. The apparatus of claim 59, further comprising a processor, wherein the processor is configured to:
decode a nonce from the authentication request;
generate a pairwise master key (PMK) based on the authentication request;
generate a pairwise transient key (PTK) based on the pairwise master key (PMK) and the nonce; and
generate the association response based on the pairwise transient key.

61. The apparatus of claim 60, wherein the processor is further configured to generate the pairwise transient key (PTK) based on a mesh peering instance identifier.

62. The apparatus of claim 60, wherein the processor is further configured to:
generate a message integrity code (MIC) based on the pairwise transient key; and
generate the association response to indicate the message integrity code.

63. The apparatus of claim 62, wherein the processor is further configured to:
assign an association identifier to the non-member device; and
further generate the association response to indicate the association identifier of the non-member device.

64. The apparatus of claim 59, further comprising a processor wherein the processor is further configured to:
generate a first message integrity code (MIC) based on the password;
decode the association request to determine a second message integrity code (MIC);
compare the first message integrity code (MIC) to the second message integrity code (MIC); and
determine whether the non-member device is associated with the member device based on the comparison.

65. The apparatus of claim 59, further comprising a processor,
wherein the processor is configured to generate the association response to include a group key for the mesh network,
wherein the receiver is further configured to receive a message from the mesh network, and
wherein the processor is further configured to decode the message based on the group key.

66. The apparatus of claim 59, further comprising a processor wherein the processor is configured to:
decode the association request to determine an association identifier,
generate a mesh-message to comprise the association identifier, and
wherein the transmitter is further configured to transmit the mesh message to the non-member device.

67. The apparatus of claim 59, further comprising a processor, wherein the processor is configured to decode an Internet Protocol address for use in communication with the non-member device from the association request.

68. The apparatus of claim 59, further comprising a processor, wherein the processor is configured to generate the authentication response to indicate at least a portion of a proposed Internet Protocol address for use by the member device in communication with the non-member device on the mesh network.

69. A member apparatus of a mesh network for associating with a non-member device of the mesh network, comprising:
means for receiving an authentication request from the non-member device;
means for transmitting an authentication response from the member apparatus to the non-member device, wherein the authentication response is based on a password;
means for receiving an association request from the non-member device; and
means for transmitting an association response from the member apparatus to the non-member device, wherein the association response is based on the password.

70. The apparatus of claim 69, further comprising:
means for decoding a nonce from the authentication request;
means for generating a pairwise master key (PMK) based on the authentication request;
means for generating a pairwise transient key (PTK) based on the pairwise master key (PMK) and the nonce; and
means for generating the association response based on the pairwise transient key.

71. The apparatus of claim 70, further comprising means for generating the pairwise transient key (PTK) based on a mesh peering instance identifier.

72. The apparatus of claim 70, further comprising:
means for generating a message integrity code (MIC) based on the pairwise transient key; and
means for generating the association response to indicate the message integrity code.

73. The apparatus of claim 72, further comprising:
means for assigning an association identifier to the non-member device; and
means for further generating the association response to indicate the association identifier of the non-member device.

74. The apparatus of claim 72, further comprising:
means for decoding the association request to determine an association identifier;
means for generating a mesh message to comprise the association identifier; and
means for transmitting the mesh message to the non-member device.

75. The apparatus of claim 69, further comprising:
means for generating a first message integrity code (MIC) based on the password;
means for decoding the association request to determine a second message integrity code (MIC);
means for comparing the first message integrity code (MIC) to the second message integrity code (MIC); and
means for determining whether the non-member device is associated with the member device based on the comparison.

76. The apparatus of claim 69, further comprising:
means for generating the association response to include a group key for the mesh network;
means for receiving a message from the mesh network; and
means for decoding the message based on the group key.

77. The apparatus of claim 69, further comprising means for decoding an Internet Protocol address for use in communication with the non-member device from the association request.

78. The apparatus of claim 69, further comprising means for generating the authentication response to indicate at least a portion of a proposed Internet Protocol address for use by the member device in communication with the non-member device on the mesh network.

79. A computer readable storage medium comprising instructions that when executed cause a processor to perform a method of associating a non-member device of a mesh network with a member device of the mesh network, the method comprising:
receiving an authentication request from the non-member device by the member device;
transmitting an authentication response from the member device to the non-member device, the authentication response based on a password;
receiving an association request from the non-member device by the member device; and
transmitting an association response from the member device to the non-member device, the association response based on the password.

80. The computer readable storage medium of claim 79, the method further comprising:
decoding a nonce from the authentication request;
generating a pairwise master key (PMK) based on the authentication request;
generating a pairwise transient key (PTK) based on the pairwise master key (PMK) and the nonce; and
generating the association response based on the pairwise transient key.

81. The computer readable storage medium of claim 80, the method further comprising generating the pairwise transient key (PTK) based on a mesh peering instance identifier.

82. The computer readable storage medium of claim 80, the method further comprising:
generating a message integrity code (MIC) based on the pairwise transient key; and
generating the association response to indicate the message integrity code.

83. The computer readable storage medium of claim 82, the method further comprising:
assigning an association identifier to the non-member device; and
further generating the association response to indicate the association identifier of the non-member device.

84. The computer readable storage medium of claim 82, the method further comprising:
decoding the association request to determine an association identifier;
generating a mesh message to comprise the association identifier; and
transmitting the mesh message to the non-member device.

85. The computer readable storage medium of claim 79, the method further comprising:
generating a first message integrity code (MIC) based on the password;
decoding the association request to determine a second message integrity code (MIC);
comparing the first message integrity code (MIC) to the second message integrity code (MIC); and
determining whether the non-member device is associated with the member device based on the comparison.

86. The computer readable storage medium of claim 79, the method further comprising:
generating the association response to include a group key for the mesh network;
receiving a message from the mesh network; and
decoding the message based on the group key.

87. The computer readable storage medium of claim 79, the method further comprising decoding an Internet Protocol address for use in communication with the non-member device from the association request.

88. The computer readable storage medium of claim 79, the method further comprising generating the authentication response to indicate at least a portion of a proposed Internet Protocol address for use by the member device in communication with the non-member device on the mesh network.
